(19) United States
(12) Patent Application Publication
(10) Pub. No.: US 2002/0055880 A1
(43) Pub. Date: May 9, 2002

(54) System for facilitating digital advertising

(76) Inventors: Eric Unold, Atlanta, GA (US); Brian Unold, Alpharetta, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/818,020

(22) Filed: Mar. 26, 2001

Related U.S. Application Data
(60) Provisional application No. 60/192,043, filed on Mar. 24, 2000.

(51) Int. Cl. G06F 17/60

(52) U.S. Cl. 705/26

(57) ABSTRACT

A system, including an apparatus and method, for facilitating the sale, reservation, purchase, management, and creation of electronic advertisements. The system enables site owners of digital signs to establish and maintain seasons of operation for their signs having rates and promotions which may differ for each day and hour of the seasons, and to control use of their digital signs by advertisers for the presentation of advertisements by an approval process for advertisers and reservations. Advertisers are assisted in forming and managing advertising campaigns having reservations for the presentation of electronic advertisements at different sites, on different days, at different times, and for different advertisements that may be created by the system using an ad builder process or that may already exist and be uploaded to or referenced by the system. Consumers are provided with the ability to readily locate further information relevant to products or services viewed in advertisements, and to purchase such products or services using electronic payment options.

### CROSS-REFERENCE TO RELATED APPLICATION

This application claims priority on United States Provisional Patent Application Ser. No. 60/192,043, filed Mar. 24, 2000, now pending.

### FIELD OF THE INVENTION

The present invention relates, generally, to the field of advertising and, in its preferred embodiments, to the field of creating electronic advertisements for products and services and managing their presentation on digital signs.

### BACKGROUND OF THE INVENTION

For many years, companies have advertised their products and services to potential customers through the use of billboards or signs that display the products or describe the services. Typically, the companies pay a rental or lease fee for the use of space on the billboards or signs for a certain period of time. Currently, the annual rental and lease fees for the use of such advertising space total approximately $100 billion.

The current use of billboards or signs for advertising products and services, however, has certain disadvantages. For example, the current use of billboards and signs suffers because of their the static nature. This deficiency results, in part, because many billboards and signs are located high off of the ground to enhance their visibility and viewing from a distance and because the posting of an advertisement on a billboard or sign is, hence, often a dangerous and time-consuming process. It is, therefore, not safe or practical to change the advertisement frequently and an advertisement usually remains on the billboard or sign for a number of months, sometimes becoming stale and not allowing a company to change its advertisement in order to reflect or take advantage of market and sales trends, changes in customer preferences, or the occurrence of a holiday or special event. For instance, if a major league baseball team advertises on a roadside billboard and has an upcoming home game for which ticket sales are lagging, the team cannot readily change its advertisement to reflect a discount that the team has decided to offer on tickets for that home game. Or, for instance, if a hotel advertises its room rates on a roadside billboard and if the hotel's occupancy is low on a particular night, there is no way for the hotel to change its advertisement to advertise a lower rate for that night in order to attract more guests and improve the hotel's occupancy.

The static nature of billboards and signs also proves to be a deficiency, in part, because many studies have shown that motion attracts the attention of the human eye and because an essential element of advertising is attracting attention to the product or service being advertised. While some billboard and sign companies have attempted to resolve this deficiency by adding flashing lights to their billboards and signs, such efforts fail to provide an advertising medium in which entire images, or portions thereof, move about the billboard or sign.

These deficiencies have led many advertisers to turn to electronic forms of advertising, such as digital signs, or electronic billboards. Digital signs appeal to advertisers because the information superhighway hosts between 8 million and 20 million users, with the numbers growing everyday. While most of the companies believe that the advertisement of their products and services via digital signs or electronic billboards is beneficial, it is, unfortunately, not possible for some companies to utilize such a medium of advertising. One reason for the inability of certain companies to advertise on digital signs is that there is, currently, no simple and quick method of creating an electronic advertisement. Many times, such an undertaking requires the use of an outside advertising agency, which can be expensive for a company of small size. Furthermore, if a company does undertake the creation of an electronic advertisement, making small adjustments or modifications to the advertisement at a later date usually requires such effort that minor changes become more trouble than they are worth. A further deficiency in the use of electronic advertising is that there is not a centralized forum for making and managing reservations for advertising time on digital signs, for controlling who may advertise on digital signs and the types and content of their electronic advertisements, and for enabling the rapid replacement of advertisements on digital signs.

Therefore, there exists in the industry, a need for a system and method for enabling the rapid creation of electronic advertisements, for rapidly changing or replacing advertisements in response to market and sales trends, changes in customer preferences, or the occurrence of a holiday or special event, for controlling access to digital signs, and for addressing these and other related, and unrelated, problems.

### SUMMARY OF THE INVENTION

Broadly described, the present invention comprises a system for facilitating digital advertising. More particularly, the present invention comprises a system for selling, reserving, purchasing, managing, and creating electronic advertisements including apparatus and methods which: (1) enable site owners of digital signs to establish and maintain seasons of operation for their signs having rates and promotions which may differ for each day and hour of the seasons, and to control use of their digital signs by advertisers for the presentation of advertisements by an approval process for advertisers and reservations; (2) allow advertisers to form and manage advertising campaigns having reservations for the presentation of electronic advertisements at different sites, on different days, at different times, and for different advertisements that may be created by the system using an ad builder process or that may already exist and be uploaded to or referenced by the system; and, (3) provide consumers with the ability to readily locate farther information relevant to products or services viewed in advertisements seen by the consumers, and to purchase such products or services using electronic payment options.

In accordance with a preferred embodiment, the system of the present invention comprises a server computer, connected to a telecommunication network, which enables the connection of site owner, advertiser, and consumer telecommunications devices for communication therewith. Preferably, the telecommunication network includes the Internet and the server computer and site owner, advertiser, and consumer telecommunication devices are capable of communicating information and/or data therebetween via the Internet. The system further comprises a plurality of software applications which provide various capabilities, including an approval center application that, upon initiation by a site owner, display lists of advertisers who desire to reserve advertising time on one or more of the site owner's sites. The lists of advertisers, preferably, include a first list of advertisers who are new and who have not been considered by the site owner, a second list of advertisers who have been previously approved by the site owner, and a third list of advertisers who have been previously rejected by the site owner. In response to the receipt of appropriate input from the site owner, the approval center application sets the advertisers' approval/rejection status for each of the site owner's sites to either “approved” or “rejected”, causing the system to not allow rejected advertisers to create reservations for the presentation of their advertisements at sites for which they have been rejected by the site owner. A similar application, the view site reservations application, displays lists of reservations for a site owner's site that include lists of reserved groups of advertising spots therefor and advertisements associated with the groups of advertising spots. Upon the receipt of input from the site owner rejecting a group of advertising spots (and, hence, the advertisement associated t therewith), the view site reservations application sets the “approval/rejection” status for the group of advertising spots to “rejected” and, as a consequence thereof, the system does not allow the presentation of the advertisement for the group of spots. By enabling site owners to select the advertisers allowed to make reservations at their sites and to determine which advertisements may be presented for particular advertising spots, the system controls who may advertise on digital signs and the types and content of their electronic advertisements.

The present invention, according to the preferred embodiment, further comprises a reservations application which, upon receipt of appropriate input from an advertiser: makes reservations in the system database for advertising spots reserved by the advertiser; causes the display to the advertiser of the advertiser's “unconfirmed” reservations (i.e., reservations made by the advertiser which are being held for a period of time and for which no payment instructions have been provided to the system); and, saves order, or payment instructions for, the advertiser's unconfirmed reservations and converts previously unconfirmed reservations into confirmed reservations. Perhaps, more importantly, the reservations application assigns advertisements to reservations previously made by the advertiser (i.e., but having no prior advertisement assignments), and re-assigns different advertisements with reservations previously made by the advertiser for which advertisements were previously selected by the advertiser. Through operation of the reservations application, the system enables the instantaneous changing of advertisements assigned to reservations, essentially, at the advertiser's discretion and, thereby allows advertisers to get the right message to potential consumers in a timely manner.

According to the preferred embodiment, the present invention further comprises an ad builder application which, in response to appropriate advertiser input, creates and saves an advertisement in the advertiser's ad portfolio and in the system's database. The ad builder application causes the display of scene templates having a plurality of image and text scenes selectable by the advertiser for dragging and dropping on time segments of an ad timeline associated with the advertisement being built. The ad builder application also causes the display of graphical symbols for music tracks which are selectable by the advertiser for inclusion in the advertisement. Upon the receipt and ordering of image and/or text scenes selections via the ad timeline, the receipt of text for text scenes, and the receipt of a selected music track, the ad builder application enables preview of the built advertisement and changing of scenes, text, and/or music. In response to the receipt of instruction from the advertiser, the ad builder application saves the built advertisement.

Accordingly, it is an object of the present invention to enable advertisers to deliver electronic advertisements to consumers.

Another object of the present invention is to provide a central forum for making and managing reservations for electronic advertising time.

Still another object of the present invention is to provide a central forum for controlling who may advertise on digital signs and the types and content of their electronic advertisements.

Still another object of the present invention is to provide tools for quickly and easily creating electronic advertisements.

Still another object of the present invention is to enable advertisers to utilize already-created electronic advertisements.

Still another object of the present invention is to enable advertisers to rapidly replace a first electronic advertisement shown at a site with a second electronic advertisement.

Still another object of the present invention is to provide advertisers with the ability to set-up and manage advertising campaigns having different electronic advertisements being presented at many different sites and on many different dates and times.

Still another object of the present invention is to enable advertisers to select sites for electronic advertisements based, at least in part, on time of day and site demographics.

Still another object of the present invention is to allow advertisers to optimize their advertising campaigns based, at least in part, on the volume of sales of products or services resulting from the electronic advertisements of their campaigns.

Still another object of the present invention is to deliver electronic advertisements to consumers at times when consumers are performing tasks particularly related to the products or services of the advertisements.

Still another object of the present invention is to allow advertisers to display full-motion video and audio-enabled electronic advertisements that are viewed on the Internet and television today.

Still another object of the present invention is to make simple the reservation and purchasing of advertising time on digital signs.

Still another object of the present invention is to enable on-line scheduling of reservations for advertising time on digital signs.

Still another object of the present invention is to allow advertisers to place reservations on-hold for a period of time prior to their purchase.

Still another object of the present invention is to enable on-line payment for advertising time on digital signs.

Still another object of the present invention is to permit site owners to set rates for electronic advertising based, at least on, the date, time of day, and site demographics.

Still another object of the present invention is to let site owners establish promotions for advertising time on their digital signs.

Still another object of the present invention is to provide consumers with easy and ready access to information related to electronic advertisements and the products or services described therein.

Still another object of the present invention is to provide consumers with referral links to advertiser's web sites.

Other objects, features, and advantages of the present invention will become apparent upon reading and understanding the present specification when taken in conjunction with the appended drawings.

### BRIEF DESCRIPTION OF THE DRAWINGS

FIG. 1 displays a block diagram representation of a system for facilitating digital advertising and the environment therefor in accordance with a preferred embodiment of the present invention.

FIG. 2 displays a block diagram representation of the server of the system for facilitating digital advertising of FIG. 1.

FIG. 3 displays a block diagram representation of a program and data domain of the server of FIG. 2.

FIGS. 4A-4C display a flowchart representation of a method of facilitating digital advertising in accordance with the preferred embodiment of the present invention.

FIGS. 5A-5B display a flowchart representation of a method of the main server application of FIG. 3.

FIGS. 6A-6B display a flowchart representation of a method of the site manager application of FIG. 3.

FIGS. 7A-7E display a flowchart representation of a method of the season planner application of FIG. 3.

FIGS. 8A-8E display a flowchart representation of a method of the view site reservations application of FIG. 3.

FIGS. 9A-9B display a flowchart representation of a method of the approval center application of FIG. 3.

FIGS. 10A-10D display a flowchart representation of a method of the campaigns application of FIG. 3.

FIGS. 11A-11C display a flowchart representation of a method of the advertisements application of FIG. 3.

FIGS. 12A-12E display a flowchart representation of a method of the ad builder application of FIG. 3.

FIG. 13 displays a pictorial representation of an ad timeline of the ad builder application of FIGS. 12A-12E.

FIGS. 14A-14I display a flowchart representation of a method of reservations application of FIG. 3.

### DETAILED DESCRIPTION OF THE PREFERRED EMBODIMENT

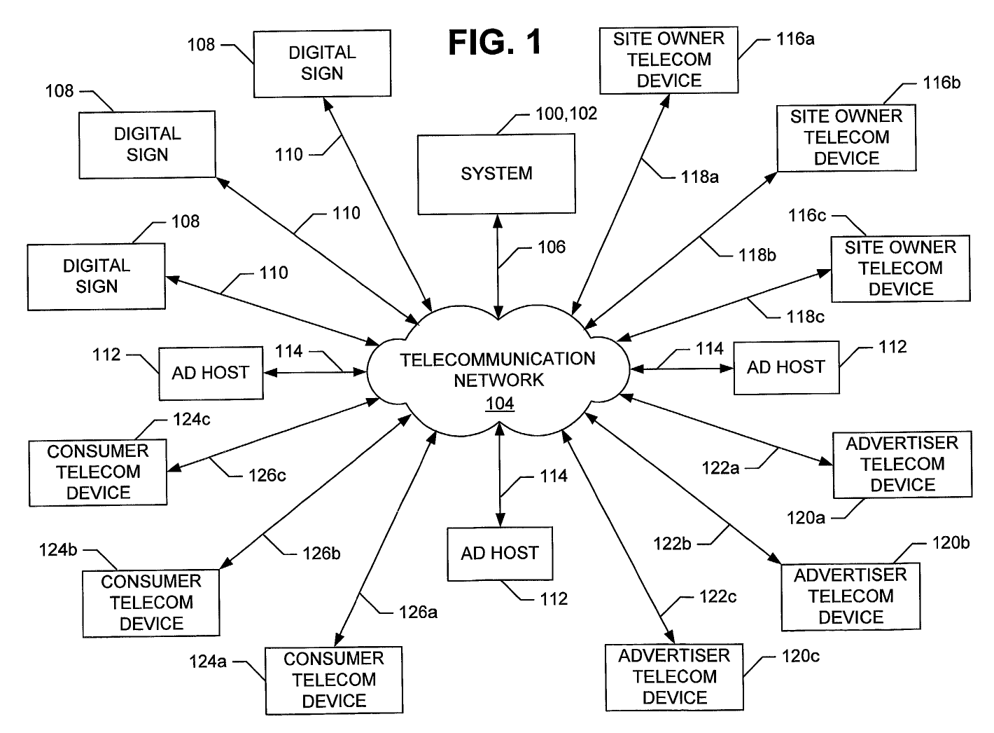

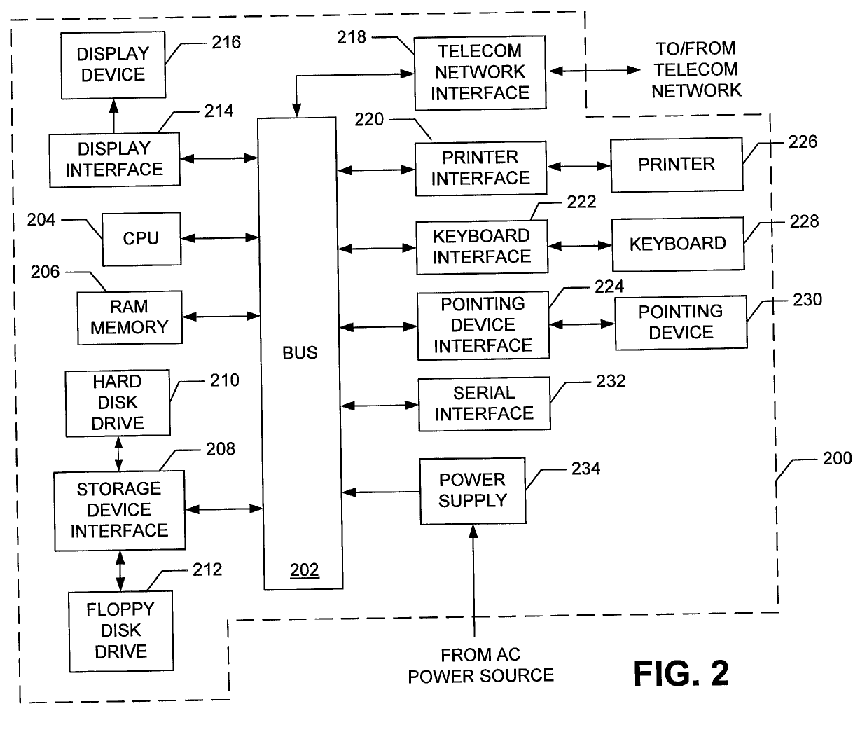

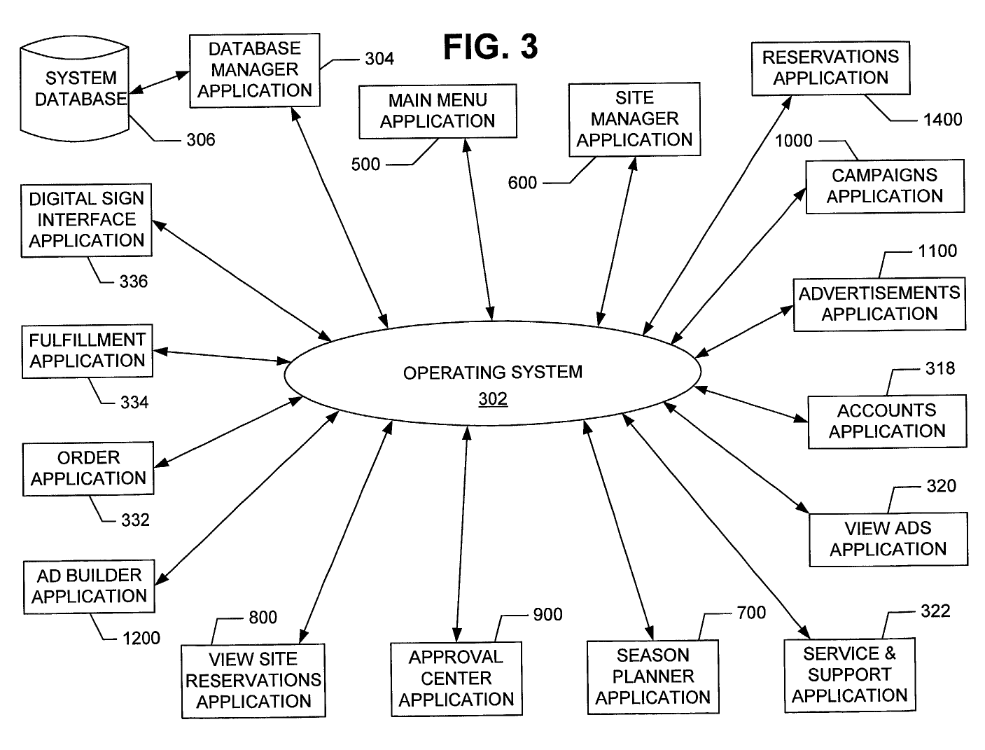

Referring now to the drawings, in which like numerals represent like components or steps throughout the several views, FIG. 1 displays a block diagram representation of a system for facilitating digital advertising 100 (also referred to herein as the “system 100”), including, but not limited to, the sales, purchase, scheduling, management, and delivery of electronic advertising, the creation of thereof, and the environment therefor in accordance with the preferred embodiment of the present invention. The system 100, preferably, comprises a telecommunications-enabled, server computer 200 (also referred to herein as the “system server 200”) residing at a first site. The system server 200 is configured with hardware and software (see FIGS. 2 and 3) appropriate to perform the tasks and provide the capabilities and functionality described herein. The system server 200 connects communicatively to a telecommunication network 104 through a communication channel 106. The system server 200 preferably, operates continuously during operation of the system 100. According to the preferred embodiment, the telecommunication network 104 includes the Internet and the system server 200 is Internet-enabled to bi-directionally communicate with the Internet. It is understood that the scope of the present invention includes a system 100 having a plurality of server computers 200 or other functionally similar devices which reside, perhaps, at different sites, which are possibly communicatively connected to each other by a local area network (and/or a wide area network or other form of communication channel), and which communicatively connect to the telecommunication network 104.

In accordance with the preferred embodiment, a plurality of digital signs 108 (also often referred to as “electronic billboards”) connect to the telecommunication network 104 through respective communication channels 110 for bi-directional communication. The communication channel 106, telecommunication network 104, and respective communication channels 110 communicatively connect the system server 200 to each of the respective digital signs 108. Each digital sign 108, preferably, comprises: a display subsystem capable of displaying video or still images received in the form of digital signals; an audio subsystem capable of producing and delivering audible sound from received digital signals therefor; a telecommunication subsystem which connects to the telecommunication network 104 for the receipt of data and/or signals therefrom associated with advertisements; and, a data processing subsystem which communicatively connects to the telecommunication subsystem and the display and audio subsystems and which is capable of receiving digital data and/or information associated with advertisements from the system 100 via the telecommunication network 104 and telecommunication subsystem, and which processes the received digital data and/or information to produce appropriate digital signals for the advertisement which are communicated to the display and audio subsystems for presentation to persons within seeing and hearing distance of the digital sign 108. The data processing subsystem includes a central processing unit (CPU), memory having appropriate capacity, storage media having appropriate capacity, and software executable by the CPU to cause each digital sign 108 to display video or still images and produce audible sound associated with an advertisement (also referred to herein as “presenting an advertisement”) in response to receipt of the advertisement via the telecommunication network 104. The displays of the digital signs 108, generally, vary in size from small 29-inch models to large billboard sizes. The display size for a particular digital sign 108 is often based upon the location of the digital sign 108 and the desired ease of viewing at various distances therefrom. Because the displays of some digital signs 108 include flat panel displays, such digital signs can be installed on walls, in display cases, and on ceilings. According to the preferred embodiment, each digital sign 108 is an intelligent, Internet-ready digital sign 108. It should be understood, however, that the scope of the present invention includes other devices of other types and forms, available now or in the future, which are capable of displaying the video and/or still images and producing the audible sounds of an advertisement in response to the receipt thereof, including, but not limited to, intelligent object browsers.

Each digital sign 108 has an owner, which may be the same or different than the owner of another digital sign 108, and resides at a location determined by its owner. Generally, the location is distant from the server's site and is, preferably, at a location where advertisers desire to advertise their products or services, including, for example and not limitation, airports, shopping malls, exhibit halls, taxi cabs, kiosks, and roadside signs or billboards. Each digital sign 108 is referred to herein as an “advertising site”, or more often, as a “site” and its owner is referred to, hence, as a “site owner”. Notably, however, the term “site” also, sometimes, refers more broadly to a plurality of digital signs 108 residing at a location. For instance, a plurality of digital signs 108 present in an exhibit hall are, sometimes, referred to collectively as a “site”. Typically, site owners operate their digital signs 108 on days and times which are appropriate for their respective locations. For instance, if a digital sign 108 resides in a mall, the site owner will operate the digital sign 108, most likely, only on the days and during the hours that the mall is open for customers. However, if a digital sign 108 resides along the side of an interstate highway, the site owner will operate the digital sign 108, most likely, twenty-four hours per day and seven days per week.

A plurality of advertisement hosts 112 (i.e., designated on FIG. 1 and also referred to herein as “ad hosts 112”) communicatively connect to the telecommunication network 104 through respective communication channels 114. Each of the digital signs 108 is connectable for communication, through respective communication channels 110, the telecommunication network 104, and respective communication channels 114, to an ad host 112 during operation of the system 100 as described below. Each ad host 112, preferably, resides at a location different than that of the system server 200 or any of the digital signs 108 and is, preferably, operated and/or maintained by an entity other than the entity which operates and/or maintains the system 100. In accordance with the preferred embodiment, each ad host 112 comprises a computer server type apparatus having appropriate storage media (and capacity thereof) and having appropriate telecommunication hardware/software and server software, to enable the ad host 112 to function as a server of advertisements which reside on the storage media of the ad host 112. Preferably, ownership of the advertisements is by the same entity that operates the ad host 112. For example and not limitation, an advertisement for Coca Cola® (owned by The Coca Cola Company) resides on the storage media of an ad host 112 operated by The Coca Cola Company at its Atlanta, Ga. headquarters. Alternatively, an advertisement for Coca Cola® resides on the storage media of an ad host 112 operated by an entity other than The Coca Cola Company and located, perhaps, at a location in a city other than Atlanta, Ga., but with which The Coca Cola Company contracts to provide ad hosting services for the advertisement. It is understood that an entity providing ad hosting services for The Coca Cola Company, for example, may also provide such services for other entities and may utilize the same hardware and software to do so. Therefore, the storage media of an ad host 112 may store and serve advertisements owned by a plurality of different entities.

A plurality of site owner telecommunication devices 116 (i.e., designated on FIG. 1 and also referred to herein as “site owner telecom devices 116” or “site owner telecom appliances 116”), possessed and used by respective site owners, are connectable for communication, at times desired by the site owners, with the system server 200 through respective and appropriate communication channels 118, telecommunication network 104, and communication channel 106. As described below, site owners utilize their site owner telecom devices 116 to provide input and/or selections to the system 100 whereby, in response thereto, the system 100, for example and not limitation, performs: the set-up and/or modification of the site owners' sites; the creation and/or modification (i.e., planing) of “seasons” (i.e., periods of time, generally, defined in terms of months during which site owners' allow advertisers to make reservations for the presentation of advertisements at their respective sites), including the assignment of rates and promotions thereto; the setting and/or changing of an advertiser acceptance/rejection status associated with each advertiser who desires to advertise on a site owner's sites (i.e., if the advertiser acceptance/rejection status associated with an advertiser is set to “accept”, the advertiser is allowed to make reservations on the site owner's sites; if the advertiser acceptance/rejection status associated with an advertiser is set to “reject”, the advertiser is not allowed to make reservations on the site owner's sites); and, the setting and/or changing of a reservation acceptance/rejection status associated with each reservation of advertisers for the presentation of advertisements on site owners' sites (i.e., if the reservation acceptance/rejection status is set to “approved”, presentation of the advertisement associated with the reservation is made; if the reservation acceptance/rejection status is set to “decline”, no presentation of the advertisement associated with the reservation is made).

Similarly, a plurality of advertiser telecommunication devices 120 (i.e., designated on FIG. 1 and also referred to herein as “advertiser telecom devices 120” or “advertiser telecom appliances 120”), possessed and used by respective advertisers, are connectable for communication, at times desired by the advertisers, with the system server 200 through respective and appropriate communication channels 122, telecommunication network 104, and communication channel 106. As described below, advertisers utilize their advertiser telecom devices 120 to provide input and/or selections to the system 100 whereby, in response thereto, the system 100, for example and not limitation, performs: the set-up and modification of the advertisers' advertising campaigns; the creation and/or modification of reservations for advertisements on site owner's sites, including the confirmation (also referred to herein as the receipt of orders or payment instructions for) previously “unconfirmed” reservations (i.e., reservations that were previously made by advertisers, but placed “on-hold” for a period of time equal to, preferably, twenty-four hours); the building and maintenance of a respective ad portfolio for each advertiser containing a plurality of advertisements for presentation at the sites of site owners; the assignment and/or changing, at any time (i.e., more than a predetermined period of time (preferably, thirty minutes) prior to the start time of respective reservations' hour-long time segments) and at the advertisers' discretion, of the advertisements associated with previously established reservations; the uploading of advertisements and the receipt of URL pointers for advertisements to be presented at the sites of site owners; and, the creation of advertisements for subsequent presentation at site owners' sites.

Also similarly, a plurality of consumer telecommunication devices 124 (i.e., designated on FIG. 1 and also referred to herein as “consumer telecom devices 124” or “consumer telecom appliances 124”), possessed and used by respective consumers, are connectable for communication, at times desired by the consumers, with the system server 200 through respective and appropriate communication channels 126, telecommunication network 104, and communication channel 106. As described below, consumers utilize their consumer telecom devices 124 to provide input and/or selections to the system 100 whereby, in response thereto, the system 100, for example and not limitation, performs: the presentation of advertisements selected for viewing by the consumers; the receipt of orders from consumers for products and/or services presented in advertisements, including the receipt of product and/or service codes respectively associated with products and/or services, of demographic information associated with the consumers, and of payment and delivery information associated with the consumers' orders; the causing of fulfillment of received orders for products and/or services and the submission of payment requests associated therewith; the making of payments to advertisers in connection with products and/or services delivered to consumers in connection with consumers' orders; and, the providing of demographic information to advertisers associated with consumers who place orders for products and/or services.

In accordance with the preferred embodiment, the pluralities of site owner, advertiser, and consumer telecom devices 116, 120, 124 comprise respective first pluralities of site owner, advertiser, and consumer telecom devices 116a, 120a, 124a, respective second pluralities of site owner, advertiser, and consumer telecom devices 116b, 120b, 124b, and respective third pluralities of site owner, advertiser, and consumer telecom devices 116c, 120c, 124c. The first pluralities of site owner, advertiser, and consumer devices 116a, 120a, 124a include, preferably, wireless digital telephony and computer type devices which are Internet-enabled and which utilize radio frequency communication channels 118a, 122a, 126a to connect and communicate with the telecommunication network 104 and to the system server 200. For example and not limitation, such telecommunication devices 116a, 120a, 124a include web-enabled (i) digital cellular telephones having an alphanumeric display, and (ii) personal digital assistant devices and portable computers having a communication interface for wireless communication. The second pluralities of site owner, advertiser, and consumer telecom devices 116b, 120b, 124b include, preferably, computers and computer type devices which utilize wire-type communication channels 118b, 122b, 126b to connect and communicate with the telecommunication network 104 and to the system server 200. For example and not limitation, such telecommunication devices 116b, 120b, 124b include desktop computers having appropriate modems which connect to and communicate via communication channels 118b, 122b, 126b providing plain old telephone service (POTS), ISDN service, xDSL service, broadband cable service, or other communication services and carrier technologies through copper, optical fiber, radio frequency, infrared, satellite, or other media. The third pluralities of site owner, advertiser, and consumer telecom devices 116c, 120c, 124c include, preferably, telephones which are connectable to the telecommunication network 104 for communication with the interactive voice response (IVR) application (not shown) of the system server 200 via analog, digital, wired and wireless, communication channels 118c, 122c, 126c. For example and not limitation, such telecommunication devices 116c, 120c, 124c include analog, digital, wired and wireless, telephones.

The telecommunication network 104, according to the preferred embodiment of the present invention, includes the Internet and communication channels 106, 110, 114, preferably, include analog, digital, wireless and wired communication channels (including, but not limited to wired communication channels providing plain old telephone service (POTS), ISDN service, xDSL service, broadband cable service, or other communication services and carrier technologies through copper, optical fiber, radio frequency, infrared, satellite, or other material). It is understood that the scope of the present invention includes other forms of communication channels available now or in the future. According to the preferred embodiment, each advertisement includes video and/or still images and/or audio which is stored in a web-enabled format, including for example and not limitation, real player video, Webpavement ADbuilder™ flash, QuickTime® movie, or flash/shockwave movie. Therefore, for an advertiser to present a television advertisement on a site owner's site, the television advertisement must first be converted to a web-enabled format. Each advertisement residing on the storage media of an ad host 112, preferably, comprises an Internet web page (or a plurality of Internet web pages) in HTML format (or other appropriate or desired format) and has assigned thereto a Universal Resource Locator (URL) (also possibly referred to herein as an “address” or “address information”) which enables access to the advertisement through the Internet by the digital signs 108. Further, each ad host 112 connects to the Internet and operates as a “web host”, hosting and serving advertisements to digital signs 108 that connect to the ad hosts 112 during operation of the system 100. It is further understood that the scope of the present invention includes other telecommunication networks 104 and ad hosts 112 having similar capabilities that are available now or in the future.

FIG. 2. displays a block diagram representation of a server 200 in accordance with the preferred embodiment of the present invention. In FIG. 2, the double-headed arrows represent bi-directional communication or signal paths between elements and the single-headed arrows represent uni-directional communication or signal paths between respective elements. The server 200, preferably, comprises a bus 202 and a central processing unit (CPU) 204, a random access memory (RAM) 206, a storage device interface 208 which, respectively, connect to the bus 202 for bi-directional communication of signals and data with each other through the bus 202. A hard disk drive 210 and a floppy disk drive 212 communicatively connect to the storage device interface 208 for the bi-directional communication of signals and data therebetween. It is understood that the scope of the present invention includes a server 200 having a plurality of hard disk drives 210 and/or other types of storage devices having appropriate capacity for the storage of operating system software, applications, and data.

The server 200 also, preferably, includes a display interface 214 and a display device 216. Display interface 214 connects to bus 202 for bi-directional communication of signals and data therewith and communicatively connects to a display device 216 for the uni-directional communication of signals and data to the display device 216. Additionally, the server 200, preferably, comprises a telecommunications network interface 218 (i.e., designated on FIG. 2 and also referred to herein as a “telecom network interface 218”) which connects to the telecommunication network 104 for bi-directional signal and data communication with site owner, advertiser, and consumer telecom devices 116, 120, 124 and ad hosts 112. In addition, the server 200, preferably, includes a printer interface 220, a keyboard interface 222, and a pointing device interface 224 which connect for bi-directional signal and data communication with a printer 226, a keyboard 228, and a pointing device 230, respectively. Further, the server 200, preferably, comprises a serial interface 232 which is connectable to external serial devices, and a power supply 234 which connects to an external source of alternating electrical current (AC). A server 200, acceptable in accordance with the preferred embodiment, is an enterprise computer server manufactured by Compaq Corporation of Houston, Tex. having appropriate versions of the elements described herein. It is understood that the scope of the present invention includes other forms of servers 200, available now or in the future or from other manufacturers.

In operation, the power supply 234 provides direct electrical current (DC) at appropriate voltage levels to the bus 202, thereby enabling operation of the server 200. The CPU 204 executes the methods and instructions of computer software programs or applications, described below, which reside on the hard disk drive 210 and which temporarily reside in RAM 206 for execution by the CPU 204. The CPU 204, operating under the control of the computer software applications, causes the server 200 to communicate with site owner, advertiser, and consumer telecom devices 116, 120, 124 for the exchange of input and output data therewith, to perform the methods and tasks described herein, and to provide the system capabilities and functionality also described herein.

FIG. 3 illustrates a program and data domain 300 of the system 100 in accordance with the preferred embodiment of the present invention. The program and data domain 300 comprises a multi-tasking, virtual operating system 302, a database manager 304, a system database 306, and a plurality of applications which, respectively, represent computer programming and data stored on hard disk drive 210. The database manager 304 and the various applications include computer software program instructions which CPU 204 executes, under the control of and in conjunction with, operating system 302 in order for the system 100 and server 200 to perform the various functions described herein and other functions not described herein. The database manager 304 also interacts, during operation of the system 100, with the applications to provide the applications with database management services (i.e., including the storage and retrieval of information and data to and from the system database 306). An operating system 302 and database manager 304 acceptable in accordance with the preferred embodiment include the Microsoft NT Operating System and the Microsoft NT Back Office Enterprise Server which are available from Microsoft Corporation of Redmond, Wash. It is understood that the scope of the present invention includes other forms of operating systems 302, including operating systems 302 based on a UNIX platform, available now or in the future or from other manufacturers. Note that, when viewing FIG. 3, the double-headed arrows of FIG. 3 indicate the bi-directional communication of signals or data between the applications and the operating system 302.

The program and data domain 300 also comprises a main menu application 500 which presents a user with menu options for selection which are appropriate for the user's classification as a site owner, advertiser, or consumer, thereby preventing a user from accessing portions of the system 100 that are restricted from access by users of the user's classification (i.e., for example, a consumer is not presented with menu options intended for a site owner or advertiser). Note, however, that a system administrator may assign some users to more than one user classification (i.e., for example, a site owner may desire to advertise its sites and, hence, is assigned to the site owner and advertiser user classifications). Preferably, the main menu options are displayed in the form of a drop-down menu positioned near the top of the user interface and are selected by a user through use of a pointing device or equivalent thereof. In response to receiving the selection of a main menu option from a user, the server 200 branches, as described herein, to the appropriate application corresponding to the selected main menu option and begins execution of the instructions of that application and, hence, operation in accordance with the method of that application.

According to the preferred embodiment, the program and data domain 300 additionally comprises a site manager application 600 which is executed in response to receipt of a site owner's selection of the “site manager” option from the main menu. During operation, the site manager application 600 enables a site owner (i.e., a user of the system having a “site owner” classification and owning or operating sites for the presentation of advertisements) to input information and/or data to the system 100 for the set-up and maintenance of sites, to initiate the operation of the season planner, approval center, and view site reservations applications 700, 900, 800 described below, and to initiate the operation of the rate and promotions applications which are not described in detail herein. Site information, generally, comprises data about a site owner's site which may be of interest to an advertiser in selecting a site for presentation of the advertiser's advertisements and includes, for example and not limitation, the site's name, its location, its hours of operation, a description of the site, and statistical information related to the site's impressions (i.e., which is a measure the number of viewers that see the site's advertisements within a particular period of time and which may cause certain advertisers to select the site for presentation of their advertisements thereon). Upon receipt of site information from a site owner, the system 100 saves the site information in the system database 306, thereby creating a new site entry or updating previously received and stored site information for a site.

The rate application, although not described in detail herein, enables a site owner to input and maintain rates to be charged to advertisers for presentation of an advertisement at the site owner's sites. After receiving input of a rate (i.e., including a rate name and dollar amount) and instruction by the site owner, the rate application associates the input rate with the site owner and saves the input rate in the system database 306. Similarly, the promotion application allows a site owner to input and maintain different types of promotions, including blanket promotions or slot promotions, which are respectively applied to the overall cost of a reservation or to the cost of particular advertising spots. Each promotion, generally, includes a promotion code and an amount. The system 100, after receiving the input of a promotion code and amount, associates the promotion with the site owner and saves the promotion in the system database 306.

The program and data domain 300, in addition, comprises a reservations application 1400 which is executed in response to receipt of an advertiser's selection of the “reservations” option from the main menu. During operation, the reservations application 1400 enables an advertiser (i.e., a user of the system having an “advertiser” classification) to provide appropriate input and/or instructions to the system 100 and in response thereto, for example and not limitation, the system 100: causes the display to the advertiser of the advertiser's “confirmed” reservations (i.e., reservations made by the advertiser and saved by the system 100, but for which payment instructions have been provided to the system 100); causes the display to the advertiser of the advertiser's “unconfirmed” reservations (i.e., reservations made by the advertiser which are being held for a period of time and for which no payment instructions have been provided to the system 100); saves order, or payment instructions for, the advertiser's unconfirmed reservations and converts previously unconfirmed reservations into a confirmed reservations; assigns and associates advertisements with reservations previously made by the advertiser, but having no prior advertisement assignments; re-assigns and re-associates different advertisements with reservations previously made by the advertiser for which advertisements were previously assigned by the advertiser; and, makes reservations in the system database 306 for advertising spots reserved by the advertiser.

Note that the term “advertising spot”, generally, refers to one of many periods of time (i.e., preferably, fifteen, thirty, or sixty seconds) during an hour-long time segment of a site's daily operation during which an advertisement having the same time length is presentable at the site. Advertising spots are, preferably, packaged for reservation into groups of advertising spots during an hour-long time segment which are selectable by an advertiser and for which a base rate, or a multiple of the base rate, is charged to an advertiser. Thus, for example and not limitation, at a particular site during a particular season, each hour-long time segment during the site's daily operation may have sixty advertising spots available for selection and reservation by an advertiser, with each advertising spot having a sixty second duration. However, because no single advertiser will likely desire to reserve an entire hour-long time segment, the system 100 groups the advertising spots into a first group of eight advertising spots, a second group of sixteen advertising spots, a third group of twenty-four advertising spots, a fourth group of forty-eight advertising spots, and a fifth group of ninety-six advertising spots. The system 100 assigns a rate equal to the base rate (i.e., established by receipt of input from the site's owner during season set-up described below) for reservation (i.e., purchase) of the first group of advertising spots by an advertiser, a rate equal to two times the base rate for reservation of the second group of advertising spots, a rate equal to three times the base rate for reservation of the third group of advertising spots, a rate equal to four times the base rate for reservation of the fourth group of advertising spots, and a rate equal to five times the base rate for reservation of the fifth group of advertising spots.

Note also that the term “reservation”, generally, refers to a single, logical booking by an advertiser of one or more groups of adverting spots at a single site during a single season for the presentation of the same advertisement during each of the individual advertising spots. Sample reservations, acceptable in accordance with the preferred embodiment of the present invention, include, for example and not limitation: a single group of advertising spots which are associated with a single, hour-long time segment (i.e., the time between the start and end times of daily operation for the site and season to which the reservation applies being divided into hour-long segments for purposes of the reservation of advertising spots) on a single date; multiple groups of advertising spots which are associated with a single, hour-long time segment on a single date; multiple groups of advertising spots which are associated with multiple, hour-long time segments on a single date; and, multiple groups of advertising spots which are associated with multiple, hour-long time segments on multiple dates. Each reservation, and the input data and selections made by the advertiser and received by the system 100 corresponding thereto, are stored by the system 100 in the system database 306. More particularly, the data stored by the system 100 for each reservation includes, but is not limited to: the name of site and season thereat for which the reservation was made; the name of the advertiser's campaign for which the reservation was made; the name of the advertisement to be presented during the advertising spots of the reservation (i.e., the name of the advertisement may be provided and stored when the reservation is made, or provided (or changed) and stored at a later date); the sub-total cost of the reservation; the promotion code and promotion amount deducted from the sub-total cost of the reservation; the grand total cost of the reservation; the “confirmed/unconfirmed” status of the reservation, payment information (i.e., including, for example, a credit card number or electronic checking account number) after the reservation is confirmed; and, for each date on which advertising spots are reserved, the hour-long time segments to which the advertising spots belong, the rate applied to the advertising spots, the number of advertising spots reserved, the discount (if any) applied to the rate for the advertising spots, and the price (or cost) of the advertising spots.

The program and data domain 300 further comprises a campaigns application 1000 which is executed in response to receipt of an advertiser's selection of the “campaigns” option from the main menu. The campaigns application 1000, in response to appropriate advertiser input, sets-up and associates new advertising campaigns with an advertiser, updates already created advertising campaigns, and stores information associated with the advertiser's advertising campaigns (i.e., names, descriptions, notes thereabout, and creation dates) in the system database 306. The campaigns application 1000, in response to appropriate advertiser input, also displays reservations for identified campaigns that are unconfirmed, confirmed, now playing (i.e., underway), and/or previously played. Upon receipt of appropriate payment information for a previously made unconfirmed reservation, the campaigns application 1000 changes the “confirmed/unconfirmed” status of the reservation to “confirmed” and updates the system database 306 appropriately. Additionally, the campaigns application 1000 receives, from an advertiser, the new identification of advertisements for reservations not previously having assigned advertisements and the revised identification of advertisements for reservations already having assigned advertisements, and accordingly updates the reservation data in the system database 306.

In accordance with the preferred embodiment, the program and data domain 300 further comprises an advertisements application 1100 which is executed in response to receipt of an advertiser's selection of the “advertisements” option from the main menu. Upon the receipt of appropriate input from an advertiser, the advertisements application 1100 displays an ad portfolio unique to the advertiser which contains advertisements and related information (i.e., which are stored in the system database 306 by the advertisements application 1100) and deletes advertisements therefrom. Preferably, the system 100 stores, for each advertisement: the advertisement's name; a description of the advertisement; the length of the advertisement (i.e., fifteen seconds, thirty seconds, or sixty seconds); the data storage format of the advertisement (i.e., real player video, Webpavement ADbuilder™ flash, QuickTime® movie, flash/shockwave movie, or URL); the size of the data file containing the advertisement; the creation and last modification dates of the advertisement; the name of the advertiser to which the advertisement belongs; a referral Internet link for display to consumers in order to encourage and enable consumers to browse the advertiser's Internet website for further information or ordering of the product and/or services (or other products and/or services) presented in the advertisement; keywords relevant to the advertisement which may enable the discovery of the advertisement upon the performance of a search therefor via the view ads application 320 described below; a file identifier (i.e., including file name and path) of the file containing the advertisement, if uploaded or created on the system 100; and, a URL pointing to the initial website page of an advertisement that resides on an ad host 112. The advertisements application 1100 also, in response to appropriate advertiser input, “creates” advertisements for use by the advertiser and, creates corresponding entries in the advertiser's ad portfolio, by uploading advertisements to the system 100, by receiving URL pointers to advertisements stored on ad hosts 112, and by building new advertisements through the ad builder application 1200 described below.

The program and data domain 300 further comprises an accounts application 318 which is executed in response to receipt of an advertiser's selection of the “accounts” option from the main menu. The accounts application 318, in response to appropriate advertiser input, sets-up and stores, in the system database 306, payment information which is selectable by the advertiser at a later date when the advertiser makes a reservation through operation of the reservations application 312 or “orders” a reservation from a display of unconfirmed reservations through the campaigns application 1000. The payment information, preferably, includes credit card and electronic checking account numbers which the system 100 uniquely associates with the advertiser.

According to the preferred embodiment of the present invention, the program and data domain 300 further comprises a view ads application 320 which the server 200 executes upon the selection of a “view ads” option from the main menu by an advertiser or consumer. The view ads application 320, upon the receipt of keywords from the advertiser or consumer, performs a search for advertisements stored in the various ad portfolios of the system 100 (i.e., the system 100 maintains a different ad portfolio for each advertiser on the system 100) and displays a list of advertisements matching the input keywords for the search. For each displayed advertisement, the view ads application 320 list includes the advertiser's name, the advertisement's name, the length of the advertisement, and the type (i.e., storage format) of the advertisement. Upon selection of an advertiser's name from the list of advertisements, the view ads application 320 causes the display of a page of the advertiser's Internet website identified by the reference link stored for the advertisement in the system database 306. Upon selection of the name of an advertisement from the list of advertisements, the view ads application 320 causes the display of the advertisement.

The program and data domain 300 further comprises a service and support application 322 which is executed in response to receipt of an advertiser's selection of the “service and support” option from the main menu. The service and support application 322, in response to appropriate user input, receives requests for service and/or support from the user and causes the forwarding of such requests to the system administrator(s).

In accordance with the preferred embodiment of the present invention, the program and data domain 300 further comprises a season planner application 700 which the server 200 executes upon the receipt of a selection of the “season planner” menu option of the site manager application 600 by a site owner. The season planner application 700, in response to appropriate input and/or selections from the site owner, receives information from the site owner for a season at a site which the site owner desires to set-up or modify, creates a new season (if the season has not already been create) associated with the site and site owner, and stores the received information in the system database 306. Preferably, the received and stored information for the season includes, for example and not limitation: a season name; a status indicator (i.e., indicating whether the season is active, pending, or over); an ad length (i.e., indicating the run-time length (i.e., fifteen seconds, thirty seconds, or sixty seconds) allowed for advertisements to be presented at the site during the season); start and end dates for the season; hours of operation of the site during the season; and, pricing mode data indicating whether pricing is to be based on the number of hourly advertising impressions or the cost per thousand impressions. Additionally, the season planner application 700 receives from the site owner, for each day of the season and for each hour-long time segment of the site's operation, the selection of rates and promotions (i.e., from the rates and promotions previously input to and received by the system 100 via the rates and promotions applications described above) for a group of advertising spots containing the minimum number of advertising spots (i.e., such that the received rate is a “base” rate as described above). The season planner application 700 stores the received rate and promotion information in the system database 306 for subsequent use in determining the cost associated with reservations created by the system 100 during operation of the reservations application 1400.

The program and data domain 300 further comprises an approval center application 900 which is executed in response to receipt of a site owner's selection of the “approval center” menu option of the site manager application 600. The approval center application 900, in response to appropriate site owner input, causes the display of respective lists of advertisers for a selected site, including advertisers which are new, advertisers that have been previously approved by the site owner and that may make reservations for the presentation of advertisements at the site, or advertisers that have been previously declined (also referred to as “disapproved” or rejected), by the site owner and that may not make reservations for the presentation of advertisements at the site. Upon the receipt of a list of new advertisers and appropriate input from the site owner, the approval center application 900 sets the “approval/rejection” status for selected advertisers to approved or rejected, and stores the associated “approval/rejection” status therefor in the system database 306. Similarly, in response to appropriate input from the site owner, the approval center application 900 sets the “approval/rejection” status associated with selected advertisers who have been already approved to rejected, or sets the “approval/rejection” status associated with selected advertisers who have been previously rejected to approved and stores the updated status in the system database 306 in association with the advertisers. Notably, the approval center application 900 is operable to approve or reject all displayed advertisers absent individual selection of advertisers from a displayed list if appropriate input is received from the site owner.

According to the preferred embodiment, the program and data domain 300 further comprises a view site reservations application 800 which is executed in response to receipt of a site owner's selection of the “view site reservations” menu option of the site manager application 600. The view site reservations application 800, in response to appropriate site owner input, causes the display of a table of reservations for a previously selected site, causes the display of advertisements associated with the reservations, sets the approval status of a group of advertising spots for a selected reservation to “declined”, and stores the approval status associated with the group of advertising spots in the system database 306. By causing the display of the table of reservations and of advertisements, and setting the approval status of a group of advertising spots for particular reservations to decline, the view site reservations application 800 enables a site owner to approve or reject individual portions of a reservation (i.e., for instance, when a particular advertisement may be acceptable for presentation in some advertising spots, but not in others).

The program and data domain 300 further comprises an ad builder application 1200 which is executed in response to receipt of an advertiser's selection of the “use ad builder” option of the advertisements application 1100. In response to appropriate advertiser input, the ad builder application 1200 creates and saves an advertisement in the advertiser's ad portfolio and in the system database 306. The ad builder application 1200 causes the display of scene templates having a plurality of image and text scenes selectable by the advertiser for dragging and dropping on time segments of an ad timeline associated with the advertisement being built. The ad builder application 1200 also causes the display of graphical symbols for music tracks which are selectable by the advertiser. Upon the receipt and ordering of image and/or text scenes selections via the ad timeline, the receipt of text for text scenes, and the receipt of a selected music track, the ad builder application 1200 enables preview of the built advertisement and changing of scenes, text, and/or music. In response to the receipt of instruction from the advertiser, the ad builder application 1200 saves the built advertisement.

In accordance with the preferred embodiment of the present invention, the program and data domain 300 further comprises an order application 332 which is executed in response to receipt of a consumer's selection of an “order” menu option of the main menu application 500. The order application 332 interacts with a consumer accessing the system 100 via the consumer's telecom device 124. Preferably, the order application 332 is web-enabled and allows a consumer to enter an order for a product or service which the consumer has viewed on a digital sign 108. The order application 332 receives consumer identification, delivery, and payment information, product code(s) (i.e., which are displayed on the digital signs 108 during display of an advertisement), and quantity data for the products or services desired for purchase by the consumer. The order application 332 stores consumer identification, delivery, and payment information, the product code(s), and quantity information therefor in the system database 306. It is understood that the scope of the present invention includes an order application 332 which utilizes an interactive voice response system to receive consumer identification, delivery, and payment information, product code(s), and quantity information from a consumer through the consumers use of a telecom device 124c and to receive and store such order information for an order in the system database 306.

The program and data domain 300 of the system 100 further comprises, in accordance with the preferred embodiment, a fulfillment application 334 which periodically retrieves order information from the system database 306. The retrieved order data includes consumer identification, delivery, and payment information, product code(s), and quantity information for each stored and unfulfilled order. The retrieved consumer identification, delivery, and payment information includes the consumer's name, shipping address, and credit card account number. The fulfillment application 334, preferably, communicates the retrieved order information to a business entity which delivers the ordered products or services to the appropriate consumers and then bills such consumers accordingly using the retrieved payment information.

According to the preferred embodiment, the program and data domain 300 further comprises a digital sign interface application 336 which periodically retrieves information from the system database 306, including site, advertisement, time segment, and advertising spot data for respective reservations. At appropriate times relative to the time segments of the reservations, the digital sign interface application 336 communicates the advertisement, time segment, and advertising spot data to appropriate digital signs 108 (i.e., the identified sites) for caching by the digital signs 108 prior to the start time of the associated time segments. The digital signs 108 process the receive data and cause presentation of the advertisements at appropriate times.

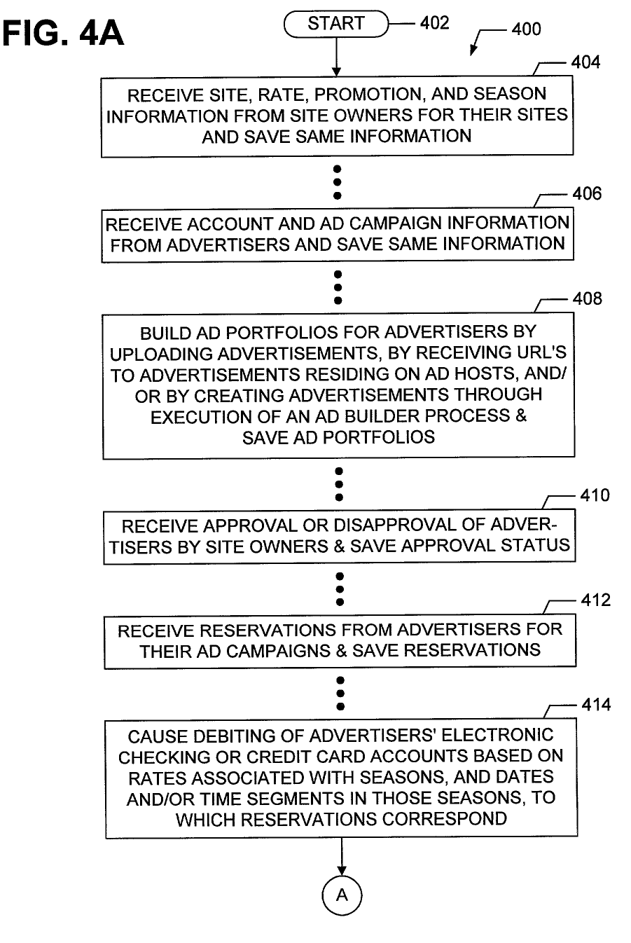

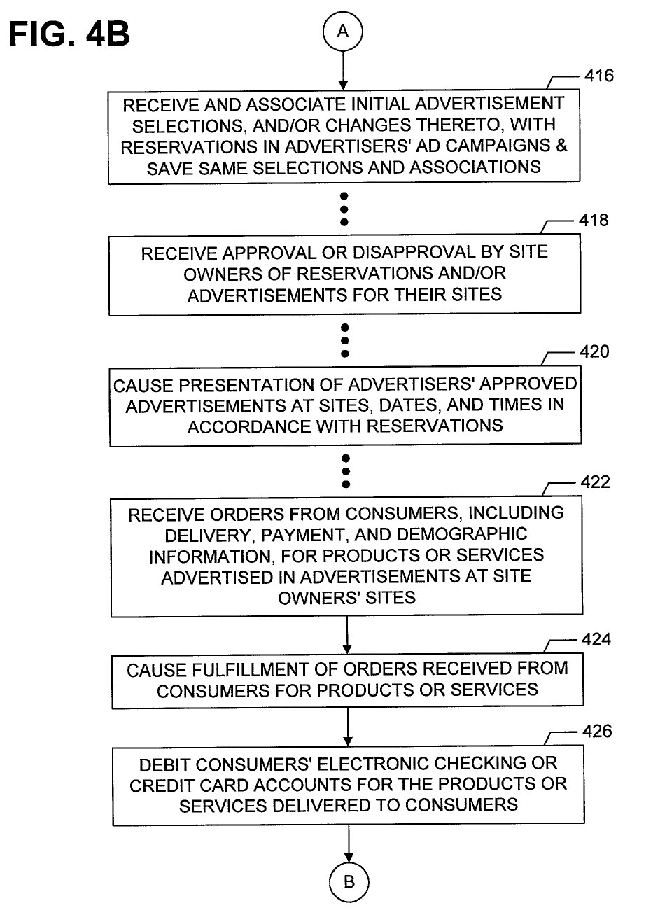

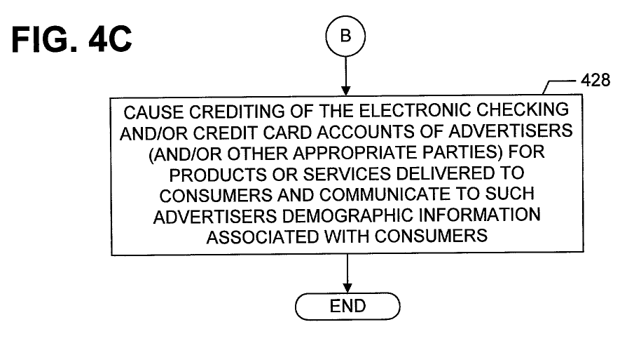

Because the system 100 is accessible by site owners, advertisers, and consumers in an asynchronous manner, it is capable of performing, and performs, many tasks in an asynchronous manner in response to direction and/or information received from site owners, advertisers, and consumers at various times. Nonetheless, to improve understanding of the present invention, FIG. 4 has been included to display a “general order” of steps of a method of the overall process 400 of the present invention which is performed by the system 100, and its server 200 through execution of appropriate software applications according to the preferred embodiment. In FIG. 4, ellipsis are often present between steps and serve to indicate that there may be a passage of time between the corresponding steps.

After starting at step 402, the method of the overall process 400 advances to step 404 where the server 200 receives rate, promotion, and season information from site owners for their sites (i.e., generally, via the site manager and season planner applications 600, 700) and saves the received information in the system database 306, thereby establishing in the system 100 sites and seasons therefor for subsequent selection by advertisers. Then, at step 406, the server 200 receives account and advertising campaign (also referred to herein as “ad campaign”) information from advertisers and saves the received information in the system database 306 (i.e., generally, via the accounts and campaigns applications 318, 1000). The account information, preferably, includes credit card account numbers and/or electronic checking account numbers which are utilized by the system 100 to charge advertisers for reserved advertising spots. During saving of the ad campaign information, the system 100 sets-up advertising campaigns in the system database 306 for the subsequent association of confirmed and unconfirmed reservations therewith. Next, at step 408, the server 200 builds ad portfolios for advertisers in the system database 306, principally via the advertisements application 1100, by uploading and saving advertisements, by receiving and saving URL's which point to advertisements residing on ad hosts, and/or by creating and saving advertisements through execution of the ad builder process 1200. The advertisements saved in the advertisers' ad portfolios are then available for subsequent selection and association with reservations made by respective advertisers.

Continuing at step 410 of the method of the overall process 400, the server 200 receives, during execution of the approval center application 900, approval or disapproval of advertisers by site owners and saves the approval status of each advertiser in the system database 306. Subsequently, when an advertiser attempts to make a reservation for an advertisement on a site owner's site, the server 200 retrieves, from the system database 306, the approval status of the advertiser for the site and determines whether the advertiser is allowed to make such a reservation. If the advertiser is not approved to make reservations at the site, the system 100 does not allow the making of reservations at the site by the advertiser. By allowing site owners to approve or disapprove of advertisers who desire to use their sites prior to the making of reservations thereon, the system 100 aids site owners in controlling the type of advertisers that advertise on their sites and/or the subject matter of advertisements presented on their sites.

Next, at step 412 of the method, the server 200 receives reservations from advertisers for their respective ad campaigns and saves the reservations in the system database 306, generally, through the execution of the reservations application 1400. The server 200, at step 414, causes the debiting of the respective advertisers electronic checking or credit card accounts by an amount based on the rates associated with the seasons, dates, and/or time segments of the reservations. Then, if no advertisements were received and associated with the reservations or if advertisers desire to change advertisements previously associated with reservations, the server 200, at step 416 and generally via execution of the campaigns application 1000, receives and associates initial advertisement selections for the reservations or changed advertisement selections therefor. The server 200 saves the selections and associations in the system database 306.

Proceeding to step 418, the server 200 receives approval or disapproval by site owners of reservations previously made for their sites and/or of the advertisements associated with the reservations and saves the approval/rejection status thereof in the system database 306. The reception and saving of approvals and disapprovals of advertisements, generally, occurs as a result of the server's execution of the view site reservations application 800 and appropriate input from site owners. Because the system 100 does not cause the presentation of disapproved, or rejected, advertisements on site owner's sites and because the system 100 enables site owners to approve or disapprove of advertisements associated with reservations, the system 100 assists site owners in controlling the type and/or subject matter of advertisements presented on their sites.

The server 200 next advances to step 420 of the method where it causes, via background execution of the digital sign interface process 336 and communication of appropriate information to respective digital signs 108, the presentation of approved advertisements at sites, dates, and times in accordance with reservations saved in the system database 306. In response to the presentation of advertisements at site owner's sites, the server 200, at step 422, receives orders from consumers, including delivery, payment, and demographic information, for the products or services of the advertisements and saves the orders in the system database 306. Then, at step 424, the server 200 causes the fulfillment of the received orders by, preferably, communicating appropriate information to business entities which provide the necessary fulfillment services. Upon fulfillment (i.e., delivery) of ordered products or services to consumers, the server 200 causes, at step 426, the debiting of the respective consumers' electronic checking or credit card accounts for the cost of the delivered products or services. Then, at step 428, the server 200 causes the crediting of the electronic checking and/or credit card accounts of the respective advertisers (and/or other appropriate parties) for the products or services delivered to consumers, and the communication of demographic information associated with the consumers to the advertisers of the delivered products or services. The reception of consumer orders, fulfillment thereof, debiting and crediting therefor occurs, generally, as a result of the server's execution of the order and fulfillment applications 332, 334.

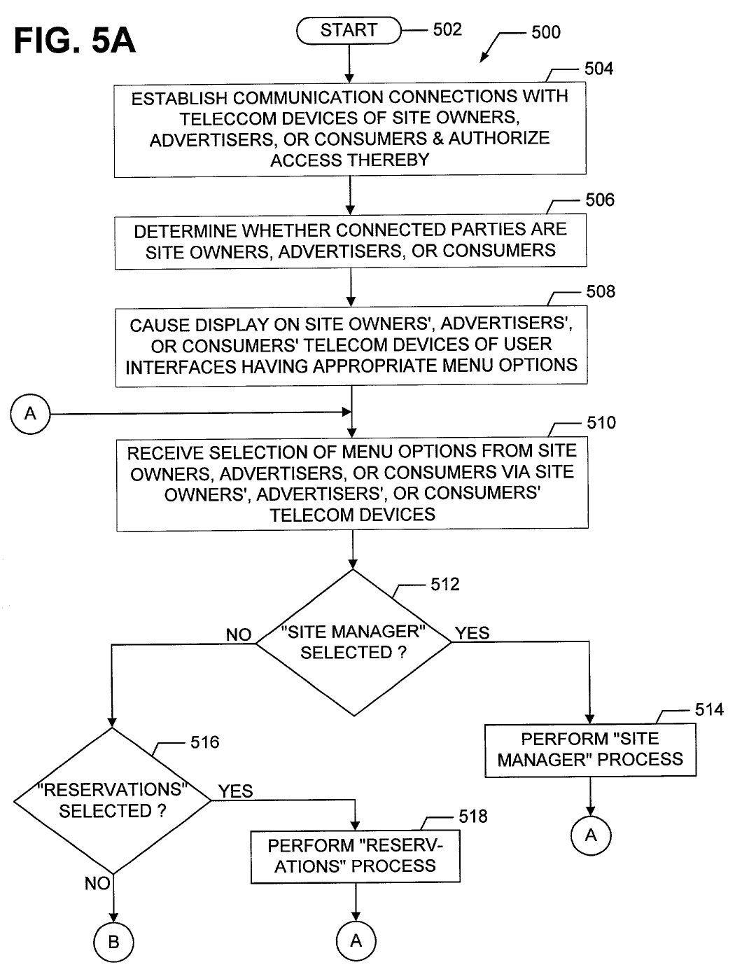

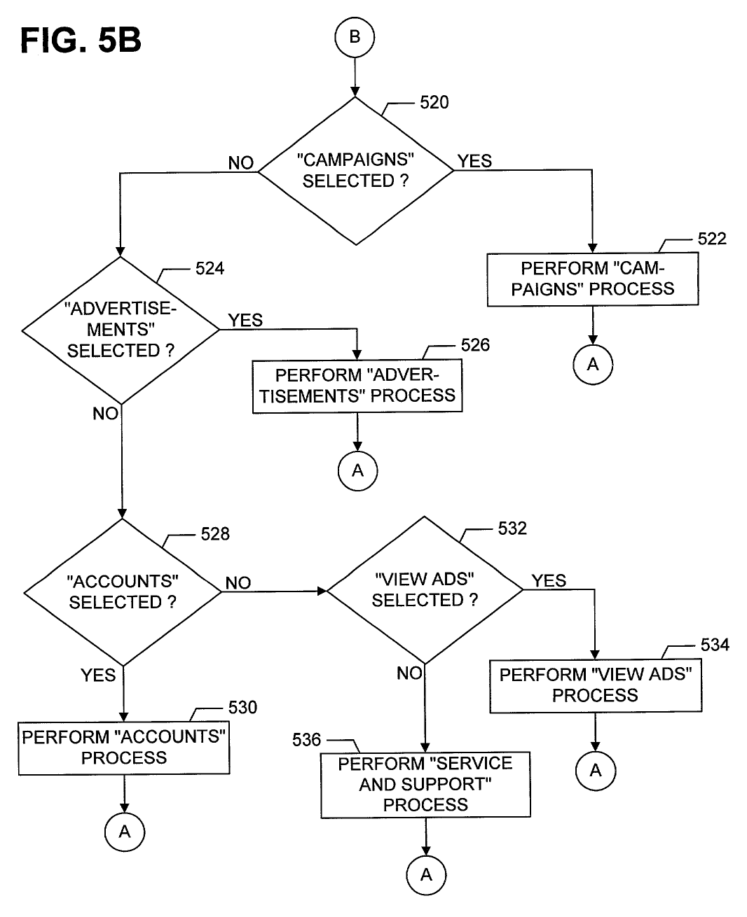

FIG. 5 displays a flowchart representation of a method of the main reservation server process 500 in accordance with the preferred embodiment of the present invention. The main reservation server process 500 causes the display of a plurality of appropriate menu options to a user, receives selections of the menu options, and based upon the received selections, branches to the appropriate applications, or processes, of the system 100 in order to provide the user with the necessary functionality. Note, however, that the main reservation server process 500 causes the display of and makes available to users only those menu options (and, hence, only the functions and/or capabilities of certain applications or processes) which are appropriate for the class of users to which the users belong (i.e., a user is classified, by the system 100, as either a site owner, an advertiser, or a consumer). Generally, a user belongs to only one class of users, but in certain instances, a user may belong to one or more classes of users. For example and not limitation, a user who is a site owner may also desire to advertise use of its sites to others at the site owner's sites (i.e., the site owner may desire to present, at the site owner's sites, advertisements to others concerning the use of the site owner's sites). As a consequence, the site owner may be classified by the system 100 as a site owner and as an advertiser and, hence, be provided with menu options appropriate for both classes of users.

After starting at step 502, the method proceeds to step 504 where the server 200, in response to a user's access of the home page of the system's Internet website via the Internet (i.e., and through necessary telecommunication or similar facilities, and a browser application running on the user's computing device), establishes communication connections with the computing device of the user (i.e., with a site owner, advertiser, and/or consumer). The server 200 then causes the display of a log-in window, on the user's computing device, having text boxes for the receipt of a user's username and password. Upon receiving the user's username and password from the user's computing device, the server 200 performs an authorization process on the username and password, and authorizes the user's access of the system 100 if the username and password represent a valid combination. Next, at step 506, the server 200 determines, based on user profile information previously stored by the system 100 for the user and associated with the received username and password, whether the authorized user is a site owner, an advertiser, or a consumer. Proceeding to step 508, the server 200 causes the display, on the user's computing device, of a user interface having a main menu with main menu options appropriate for the user (i.e., main menu options for a site owner, advertiser, and/or consumer). Then, at step 510, the server 200 awaits and receives the selection of a main menu option from the user, via the user's computing device.

At step 512, the server 200 determines whether the user selected the “site manager” main menu option. If so, the server 200 branches to step 514 where it operates in accordance with the method of the “site manager” application 600 (also possibly referred to herein as the “site manager” process 600). Upon termination of the site manager process 600, the server 200 returns to step 510 to await and receive selection of a main menu option by the user via the user's computing device. If the server 200 determines, at step 512, that the user did not select the “site manager” main menu option, the server 200 advances to step 516 where it ascertains whether the user selected the “reservations” main menu option. If so, the server 200, at step 518, operates according to the method of the “reservations” application 1400 and, upon termination thereof, loops back to step 510 described above. If not, the server 200 proceeds to step 520 of the method where it decides whether the user selected the “campaigns” main menu option. If so, at step 522, the server 200 operates in accordance with the method of the “campaigns” application 1000 (also possibly referred to herein as the “campaigns” process 1000). After termination of such operation, the server 200 branches back to step 510 to await and receive selection of a main menu option by the user via the user's computing device.

If, at step 520, the server 200 decides that the user did not select the “campaigns” menu option, the server 200 determines, at step 524, whether the user selected the “advertisements” main menu option. If so, the server 200 performs, at step 526, according to the method of the “advertisements” application 1100 (also referred to herein possibly as the “advertisements” process 1100) and upon termination thereof, returns to step 510 described above. If the server 200 decides that the user did not select the “advertisements” main menu option, the server 200 then, at step 528, ascertains whether the user selected the “accounts” main menu option. If so, the server 200 operates in accordance with the method of the “accounts” application 318 at step 530 and then returns to step 510 await and receive selection of a main menu option by the user via the user's computing device. If not, the server 200 determines, at step 532, whether the user selected the “view ads” main menu option. If the “view adds” main menu option was selected by the user, the server 200 advances to step 534 where it operates according to the method of the “view ads” application 320. After termination of such operation, the server 200 loops back to step 510 to await and receive selection of a main menu option by the user via the user's computing device. If the server 200 determines, at step 532, that the user did not select the “view ads” main menu option, then the user selected the “service and support” main menu option. Therefore, the server 200 branches to step 536 of the method where it operates in accordance with the method of the “service and support” application 322. Upon termination of operation according to the method of the “service and support” application 322, the server 200 returns to step 510 to await and receive selection of a main menu option by the user via the user's computing device.

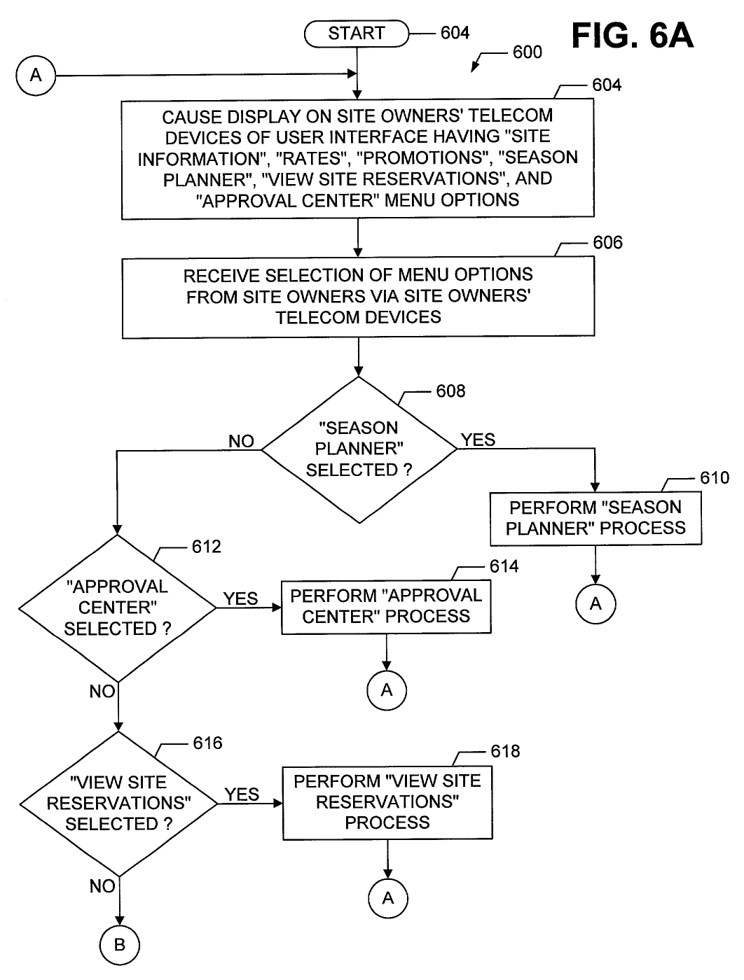

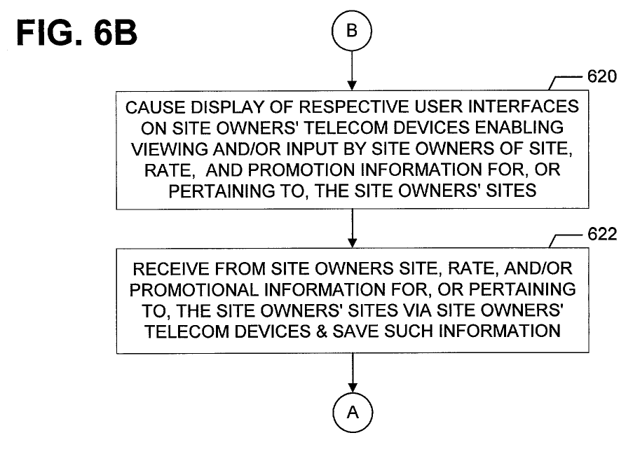

FIGS. 6A-6B depicts a flowchart representation of a method employed by the site manager application 600 (also referred to herein possibly as the “site manager process 600”) in accordance with the preferred embodiment of the present invention. The site manager application 600, via the site owner's telecom device 116 and a pre-established telecommunication link with the server 200, enables and assists site owners in setting-up and managing sites and seasons for their sites, and enables and assists site owners in the approval or rejection of advertisers and of individual reservations for advertisements on their sites. After starting at step 602, the method proceeds to step 604 where the server 200 causes the display of a site manager user interface on the display of a site owner's telecom device 116. The site manager user interface, preferably, comprises a menu of site owner selectable options, including, but not limited to, “site information”, “rates”, “promotions”, “season planner”, “view site reservations”, and “approval center” (also referred to herein as the “site manager menu options”). Upon causing the display of the user interface on the site owner's telecom device 116, the server 200 receives, at step 606, a selection of one of the site manager menu options from the site owner's telecom device 116 in response to a selection made by the site owner.

At step 608, the server 200 determines whether the site owner selected the “season planner” site manager menu option. If so, the server 200 branches to step 610 where it operates in accordance with the method of the season planner application 700, described below. Upon termination of the season planner application 700, the server 200 returns to step 606 to await and receive selection of a site manager menu option by the site owner via the site owner's telecom device 116. If the server 200 determines, at step 608, that the site owner did not select the “season planner” site manager menu option, the server 200 advances to step 612 where it ascertains whether the site owner selected the “approval center” site manager menu option. If so, the server 200 branches to step 614 where it operates according to the method of the approval center application 900 described below. Upon termination of such operation, the server 200 loops back to step 606 to await and receive selection of a site manager menu option by the site owner via the site owner's telecom device 116.

If, at step 612, the server 200 ascertains that the site owner did not select t the “approval center” site manager menu option, the server 200 moves to step 616 of the method where it decides whether the site owner selected the “view site reservations” site manager menu option. If so, the server 200 continues operation, at step 618, in accordance with the method of the view site reservations application 800 (described below) until termination, at which time, the server 200 returns to step 606 to await and receive selection of a site manager menu option by the site owner via the site owner's telecom device 116. If the server 200 decides, at step 616, that the site owner did not select the “view site reservations” site manager menu option, the server 200 advances to step 620 where it causes the display, on the site owner's telecom device 116, of appropriate user interfaces for the viewing and receipt of site, rate, and promotion information by the site owner.

In particular, the user interface for site information enables the site owner to input and the system 100 to receive information, via the site owner's telecom device 116, about a site, including, for example and not limitation, a site name, site operation start and end times, a site description, an address for the site location, a contact name for issues related to the site, a telephone number and email address for the contact, the number or amount of daily impressions, daily traffic, and daily transactions for the site (i.e., such information may be utilized by advertisers in selecting sites for the presentation of their advertisements). Similarly, the user interface for rates enables the site owner to input and the system 100 to receive information, via the site owner's telecom device 116, about rates to be charged by the site owner for the presentation of advertisements at the site owner's site. Rate information, preferably, includes a rate name, a rate (i.e., a dollar amount to be paid by an advertiser for presenting an advertisement during eight spots in an hour-long time segment), and descriptive information about the rate. Also similarly, the user interface for rates enables the site owner to input and the system 100 to receive information, via the site owner's telecom device 116, about promotions (i.e., discounts) to be applied to rates charged by the site owner for the presentation of advertisements at the site owner's site. Promotion information, preferably, includes a promotion name, a promotion (i.e., a dollar amount to be credited by a site owner to the amount charged to an advertiser for presenting an advertisement during eight spots in an hour-long time segment), and descriptive information about the promotion. Both rate information and promotion information are utilized by the method of season planner application 600, described below, when setting-up seasons for advertiser reservations.

After causing the display, on the site owner's telecom device 116, of appropriate user interfaces for the viewing and receipt of site, rate, and promotion information by the site owner, the server 200 continues operation according to step 622 of the method. At step 622, the server 200 respectively awaits and receives site, rate, and promotion information from the site owner and saves such information for subsequent use.

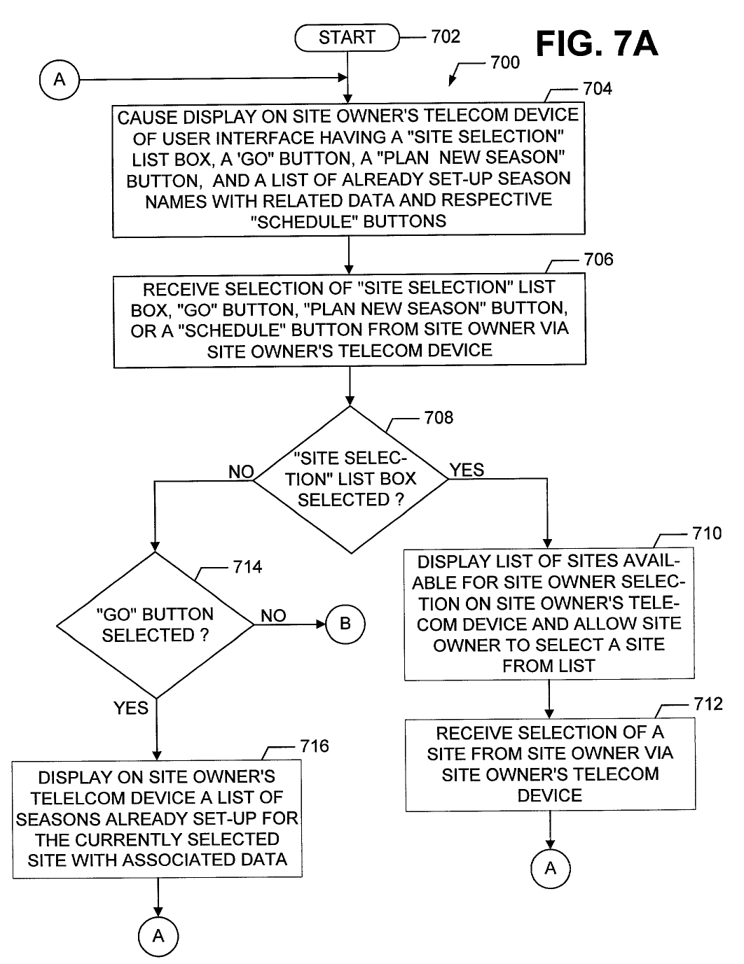

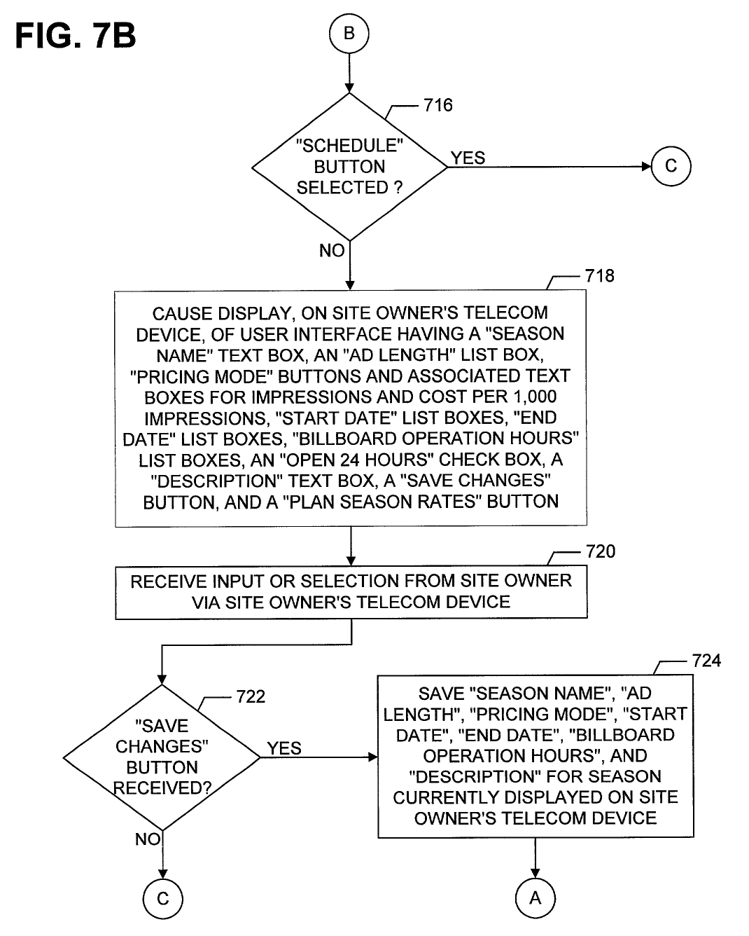

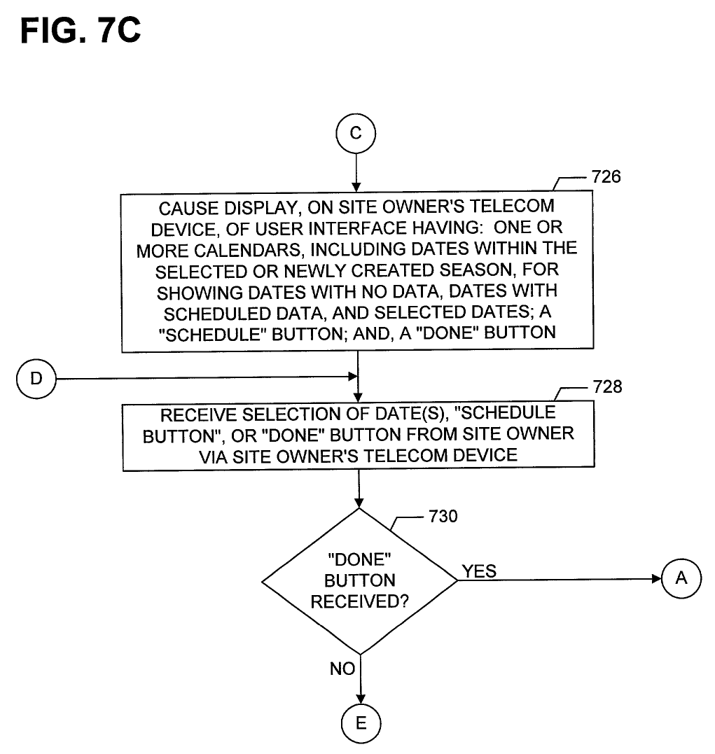

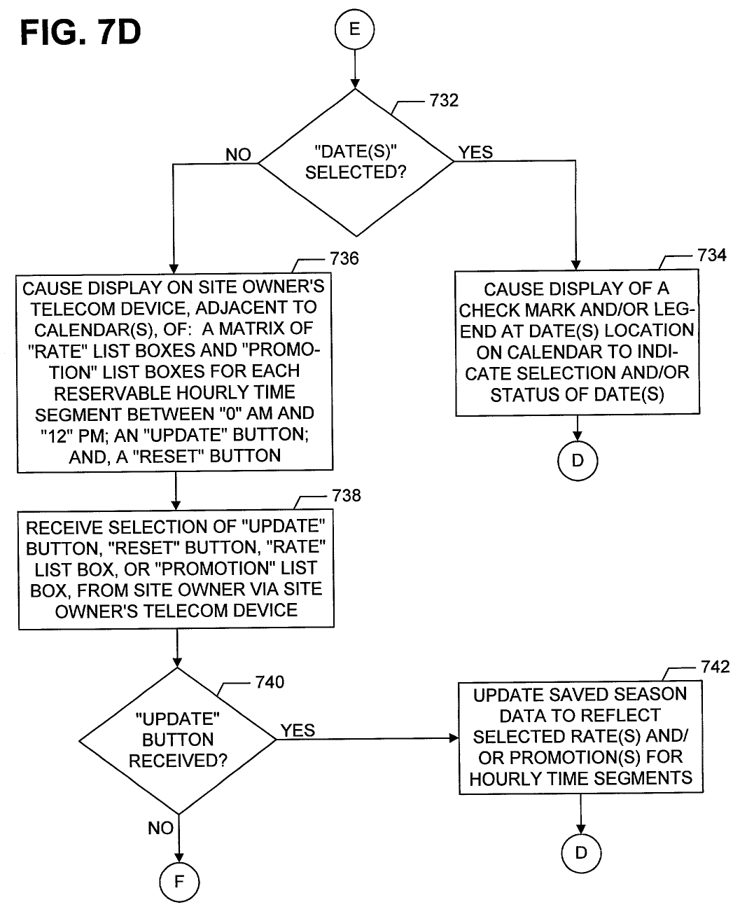

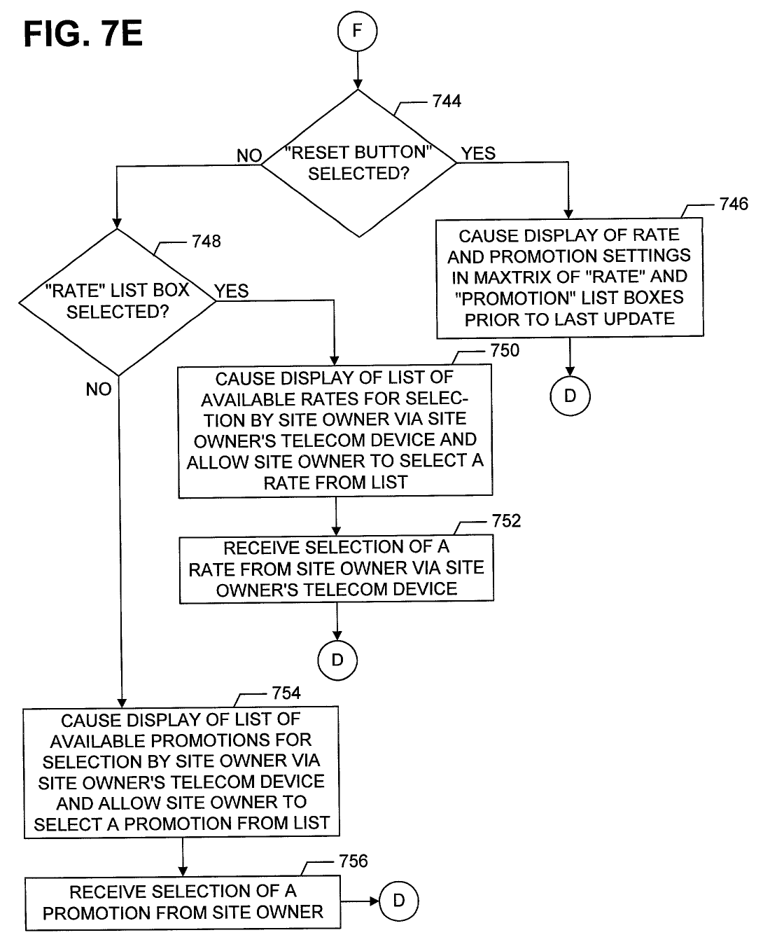

FIG. 7 illustrates a flowchart representation of a method employed by the season planner application 700 in accordance with the preferred embodiment of the present invention. The season planner application 700 enables a site owner, via the site owner's telecom device 116 and a pre-established telecommunication link with the server 200, to set-up and maintain (i.e., establish and update relevant data, including, but not limited to, names, dates and hours of operation, rates, and promotions) discrete periods of time known as “seasons”(i.e., which may include one or more days, months, or years) during which advertisements are shown on the site owner's electronic billboard located at the site associated with the season. After starting at step 702, the method proceeds to step 704 where the server 200 causes the display of a season planner user interface on the display of a site owner's telecom device 116. The season planner user interface, preferably, comprises a “site selection” drop-down list box which displays the name of the currently selected site for which seasons are being set-up or maintained by the sit owner and which enables the selection of a different site, as necessary, by the site owner. The season planner user interface also, preferably, comprises a “go” button, and a “plan new season” button. After causing the display of the user interface on the site owner's telecom device 116, the server 200 receives, at step 706, a selection of one of the season planner user interface elements from the site owner's telecom device 116 in response to a selection made by the site owner.

Continuing at step 708, the server 200 determines whether the site owner selected the “site selection” drop-down list box. If so, at step 710, the server 200 causes the display, on the display of the site owner's telecom device 116, of a drop-down list of sites which are available for selection by the site owner and allows the site owner to select a site from the list. Then, at step 712, the server 200 receives a selection of a site by the site owner and updates the “site selection” drop-down list box to display the selected site name. Upon updating the “site selection” drop-down list box, the method loops back to await further input from the site owner. If, at step 708, the server 200 determines that the “site selection” drop-down list box was not selected by the site owner, the server 200 then determines, at step 714, whether the site owner selected the “go” button. If so, the server 200, at step 716, causes the display on the site owner's telecom device 116 a list of already created seasons, if any, with each season having: a season name; a status indicator (i.e., indicating that the season is active, pending, or over); an ad length (i.e., indicating the run-time length (15 seconds, 30 seconds, or 60 seconds) allowed for the advertisements to be shown during the season); a start date; an end date; season coverage (i.e., a percentage indicating, generally, how much of the season has been planned by the site owner's input of rates and promotions for the season); and various selectable buttons, including a “schedule” button. Then, the method loops back to step 706 to await further input from the site owner.

If, at step 714, the server 200 concludes that the “go” button was not selected by the site owner, the site owner selection is evaluated at step 716 to decide if the site owner selected a “schedule” button associated with a season present in the list of already existing seasons displayed on the site owner's telecom device 116. If so, the method advances to step 730 described below. If not, the site owner selected the “plan new season” button and the server 200 causes the display, on the site owner's telecom device 116, of a “new season” user interface having: a “season name” text box (i.e., for reception of a name for the new season); an “ad length” drop-down list box (i.e., to enable selection of an ad length (i.e., 15, 30, or 60 seconds) for the new season); “pricing mode” buttons and associated “impressions” and “cost per 1,000 impressions” text boxes (i.e., to allow the cost of reservations during the season to be valued based on the number of hourly advertising impressions or the cost per 1,000 impressions); “start date” drop-down list boxes (i.e., for selection of a starting month, day, and year for the new season); “end date” drop-down list boxes (i.e., for selection of an ending month, day, and year for the new season); “billboard operation hour” drop-down list boxes (i.e., for selection of daily starting and ending times of operation for the billboard at the site); an “open 24 hours” check box (i.e., for indicating that the billboard is operational 24 hours per day); a “description” text box (i.e., for receipt of a description of the new season); a “save changes” button (i.e., for saving the information, or data, input for the new season); and, a “plan season rates” button (i.e., to enable input and association of rates with the hour-long time segments of each day of the new season).

Proceeding to step 720 of the method, the server 200 awaits and receives an input or selection by the site owner from the new season user interface. Then, at step 722, the server 200 considers the input or selection and determines whether the “save changes” button was selected by the site owner. If so, the server 200 saves, at step 724, the new season name and associated information (e.g., permitted ad length, pricing mode and related data, start date, end date, billboard operation hours, and description of the season) input by the site owner through use of the new season user interface. The method then loops back to step 704 to cause the display of the season planner user interface. If not, at step 726, the server 200 causes the display, on the display of the site owner's telecom device 116, of a “rate planning” user interface having: one or more calendars which include dates within the newly created season's start and end dates and which indicate, through use of a legend, dates having no rate or promotion data associated therewith, dates having rate or promotion data associated therewith, and dates which have been selected by the site owner; a “schedule” button; and, a “done” button.

The server 200 continues operation in accordance with the method at step 728, where it receives the selection by the site owner of a date from a calendar, the “schedule” button, or the “done” button of the “rate planning” user interface. At step 730, the server 200 determines whether the selection is the “done” button. If so, the method branches back to step 704, described above, to cause display of the “season planner” user interface. If not, the method advances to step 732 where the server 200 decides if the site owner's selection was a date from a displayed calendar. If so, the server 200 causes the display of a check mark adjacent to the date to indicate its selection by the site owner. The method loops back to step 728 to await and receive a site owner selection from the “rate planning” user interface. If not, then the “schedule” button was selected by the site owner to initiate rate and/or promotion selection and assignment to each of the hour-long time segments, for the selected date, during which the electronic billboard operates at the site. In response, at step 736, the server 200 causes the display, adjacent to the calendar(s) already displayed on the site owner's telecom device 116 as part of the “rate planning” user interface, of a row and column matrix having rows corresponding to each hour-long time segment that the selected site operates and columns for each row identifying the particular hour-long time segment to which the row pertains, a “rate” drop-down list box, and a “promotion” drop-down list box. The displayed “rate planning” user interface further comprises an “update” button and a “reset” button, in addition to other features not described herein.

At step 738, the server 200 awaits and receives the selection of the “update” button, the “reset” button, a “rate” drop-down list box, or a “promotion” drop-down list box from the site owner via the site owner's telecom device 116 and the pre-established telecommunication link with the server 200. Then, the server 200 determines, at step 740, whether the site owner selected the “update” button. If so, at step 742, the server 200 saves the newly created season and associated information (i.e., and/or updates previously stored season data) input therefor, including the rates and/or promotions selected by the site owner for various hour-long segments, and returns to step 728 of the method to await further input by the site owner. If not, the method advances to step 744 where the server 200 checks the site owner's input selection to ascertain whether the site owner selected the “reset” button. If the “reset” button was selected by the site owner, the server 200 causes the current display of rate and promotion settings in the “rate” and “promotion” drop-down list boxes to be reset to their values prior to the site owner's last selection of the “update” button. If the “reset” button was not selected by the site owner, the server 200 proceeds to step 748 of the method where the site owner's selection is analyzed to determine if the site owner selected a “rate” drop-down list box. If so, the server 200 causes the display, on the site owner's telecom device 116, of a drop-down list of rates for selection by the site owner and allows the site owner to make such a selection. Upon receiving a rate selection from the site owner, the server 200 updates the “rate” drop-down list box with the newly selected rate at step 752 and loops back to step 728 to await further input from the site owner.

If the server 200 determines, at step 748, that the site owner's input was not a selection of a “rate” drop-down list box, then the site owner selected a “promotion” drop-down list box from the matrix. Proceeding to step 754 of the method, the server 200 causes the display of a dropdown list of promotions on the site owner's computer for selection by the site owner and awaits, at step 756, a selection of one of the promotions by the site owner. Upon receiving the selection of a promotion by the site owner at step 756, the method branches back to step 728 to await further input by the site owner.

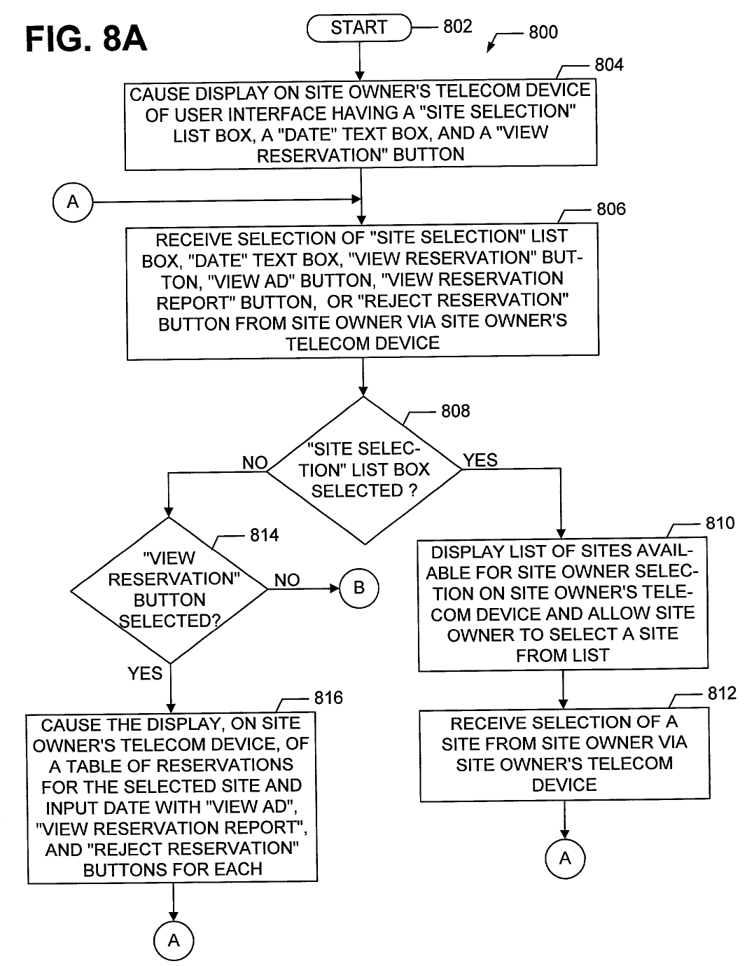

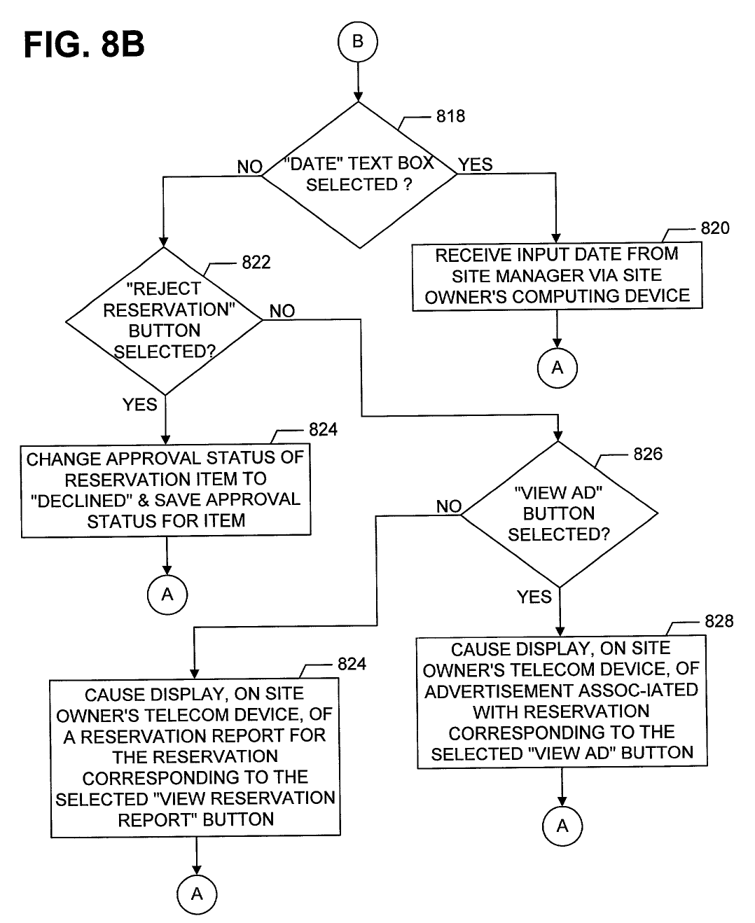

FIG. 8 illustrates a flowchart representation of a method utilized by the “view site reservations” application 800 (also referred to herein as the “view site reservations process”) in accordance with the preferred embodiment of the present invention. The view site reservations application 800 principally enables a site owner, through the site owner's telecom device 116 and a pre-established telecommunication link with the server 200, to view reservations of advertising time which have been made by advertisers for a site owned, or operated, by the site owner, to view the advertisements which will run during the reserved advertising times, and to approve or disapprove (i.e., decline) individual items (i.e., groups of advertising slots and associated advertisements) of the reservations. After starting at step 802, the method proceeds to step 804 where the server 200 causes the display of a “view site reservations” user interface on the display of the site owner's telecom device 116. The “view site reservations” user interface comprises a plurality of elements, including, but not limited to: a “site selection” drop-down list box which enables the site owner to select a site for which the site owner desires to review and/or approve/decline reservations; a “date” text box which enables the site owner to input a date for which the site owner desires to review and/or approve/decline reservations for the site selected via the “site selection” drop-down list box; and, a “view reservation button” which enables the site owner to request that a table of reservations for the selected site and input date be displayed on the site owner's telecom device 116.

At step 806, the server 200 awaits the selection of a drop-down list box (i.e., the “site selection” drop-down list box), text box (i.e., the “date” text box), button (i.e., the “view reservations” button, a “view ad” button, a “view reservation report” button, a “view ad” button, or a “reject reservation” button) or other user interface element from the site owner via a user interface displayed on the site owner's telecom device 116. Upon receiving an input or selection from the site owner, the server 200 evaluates the input or selection at step 808 to determine whether the site owner selected the “site selection” drop-down list box. If so, the server 200, at step 810, causes the display, on the site owner's telecom device 116, of a drop-down list of the names of the site owner's sites which are available for selection by the site owner and allows the site owner to select a site. At step 812, the server 200 receives the selection of a site by the site owner from the drop-down list, updates the “site selection” drop-down list box to reflect the name of the selected site, and loops back to step 806 of the method to await further input by the site owner.

If, at step 808, the server 200 determines that the “site selection” drop-down list box was not selected by the site owner, the server 200 advances to step 814 of the method where it considers whether the site owner selected the “view site reservation” button. If the server 200 determines, at step 814, that the site owner selected the “view site reservation” button from the “view site reservations” user interface, the server 200 causes the display, on the display of the site owner's telecom device 116, of a table of reservations, if any, for the selected site and input date at step 816. The table of reservations includes reservations that have been made by advertisers for each hour-long time segment of operation of the selected site on the date input by the site owner. Each row of the table corresponds to an hour-long time segment and includes, in various columns: the occupancy of the time segment (i.e., what percentage of the hour has been reserved for advertisements by advertisers); in a drop-down list box, reservations selectable by the site owner, including the names of the advertisers who have reserved time during the hour-long time segment with the names and presentation frequency of the corresponding advertisements to be presented for the advertisers during the respective time segment; a “view ad” button (i.e., to enable the site owner to view the advertisement associated with the reservation displayed in the drop-down list box); a “view reservation report” button (i.e., to enable the site owner to view a “reservation report” showing information about the reservation displayed in the drop-down list box; and, a “reject reservation” button (i.e., to enable the site owner to reject particular reservation items, as opposed to rejecting an advertiser, and all of an advertiser's reservations, which is performed by the site owner through the “approval center” application 900 described below). After the display of the table of reservations at step 816 by the server 200, the method loops back to step 806 where the server 200 awaits further input or selections by the site owner.

If, alternatively, the server 200 determines, at step 814, that the site owner did not select the “view site reservations” button, the server 200 decides, at step 818, whether the site owner's input constitutes a selection of the “date” text box. If so, the server 200 proceeds to step 820 of the method where it awaits and receives an input date from the site owner via the “date” text box and the site owner's telecom device 116. Then, according to the method, the server 200 branches back to step 806 to await further input or selections by the site owner. However, if the server 200 decides, at step 818, that the site owner's input was not a selection of the “date” text box, the server 200 continues to step 822 of the method where it checks to see if the site owner's input was a selection of a “reject reservation” button from the displayed table of reservations. If not, the server 200 advances to step 826 of the method described below. If so, the server 200 causes the display, on the site owner's telecom device 116, of a “reservation report” which displays summary and detailed information about the reservation currently displayed (i.e., in the drop-down list box with which the selected “reject reservation” button is associated) and allows the site owner to reconsider rejection of the reservation.

In conjunction with the display of the “reservation report”, the server 200 displays a “reject” button and a drop-down list box of reasons for the rejection on the site owner's telecom device 116. Selection of the “reject” button and selection of a reason for the rejection are required by the site owner to reject an item of the reservation. If the site owner rejects the item of the reservation accordingly, the server 200 changes the approval status associated with the reservation to “declined”, “rejected”, or “disapproved” and saves the modified approval status. The server 200 also subsequently provides notice of the rejection and the reason therefor to the advertiser. If the site owner does not reject an item of the reservation (i.e., by selection of a “cancel” button not described herein), the server 200 causes the removal of the “reservation report” from the display of the site owner's telecom device 116 and loops back, in accordance with the method, to step 806 where it awaits further input from the site owner.

At step 826 of the method, the server 200 ascertains whether the site owner's selection corresponds to a “view ad” button. If so, the server 200 causes the display, on the site owner's telecom device 116, of the advertisement associated with the reservation currently displayed in the drop-down list box with which the selected “view ad” button is associated. Such display of the advertisement assists the site owner in determining whether to approve or reject the corresponding reservation. Upon completion of the displaying of the advertisement, the server 200, in accordance with the method, loops back to step 806 to await site owner input. If, at step 826, the server 200 ascertains that the site owner's selection was not a “view ad” button, the site owner selection was of a “view reservation report” button and, hence, at step 830, the server 200 causes the display, on the site owner's telecom device 116, of a “reservation report” associated with the reservation currently displayed in the drop-down list box with which the selected “view reservation report” button is associated.

The “reservation reports” described herein, preferably, comprise summary and detail portions. The summary portion of a “reservation report”, preferably, includes, for the reservation: a reservation number assigned by the system when the reservation was made by the respective advertiser; an order number assigned by the system when the reservation was confirmed by the respective advertiser; an account number associated with the respective advertiser; the date on which the reservation was made; the date on which the reservation was confirmed; the total cost of the reservation; the name of the advertiser's campaign to which the reservation belongs; the name of the site for which the reservation was made; the name of the advertisement associated with the reservation; the name of the site owner's season in which the reservation was made, and the time zone of the site to which the reservation applies. The detail portion of a “reservation report”, preferably, includes: the date, show time, rate, number of spots, discount, and price of the reservation; the cost per thousand impressions; the number of estimated impressions that the advertisement associated with the reservation will receive; any promotion-related credit; and, the total cost of the reservation.

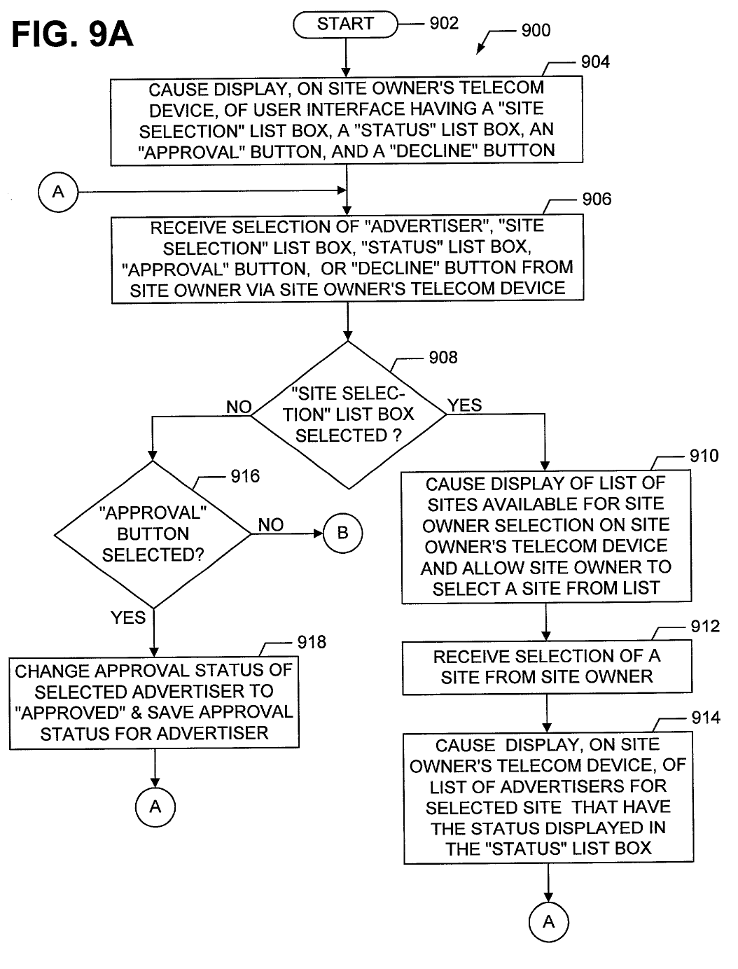

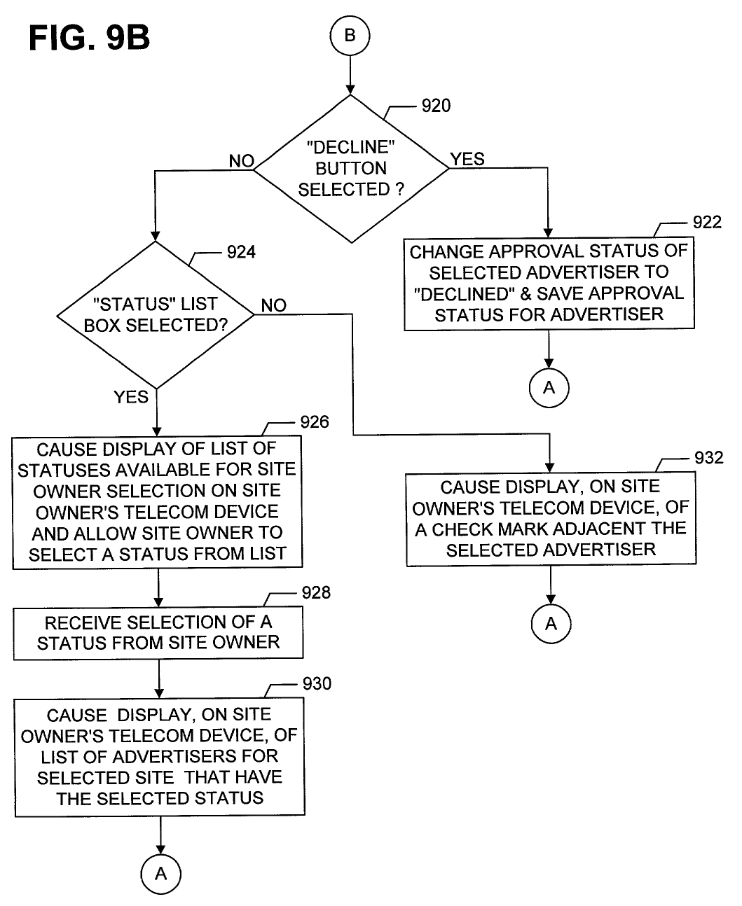

FIG. 9 depicts a flowchart representation of a method utilized by the “approval center” application 900 (also referred to herein as the “approval center process”) in accordance with the preferred embodiment of the present invention. The approval center application 900 enables a site owner, through the site owner's telecom device 116 and a pre-established telecommunication link with the server 200, to approve or “decline” (i.e., or “reject”, or “disapprove”) advertisers, on an individual basis, with respect to whether advertisers may make reservations and display advertisements on particular sites owned by the site owner. An “approved” advertiser may make reservations and associate advertisements therewith for presentation on the sites for which the advertiser is approved by the site owner. A “rejected” advertiser cannot, however, make reservations on sites for which the site owner has rejected the advertiser. Although not described herein in detail, the approval center application 900 also enables a site owner to approve or reject an advertiser for all of the site owner's sites through additional user interface elements. Additionally, it should be remembered that a site owner may also “approve” or “reject” individual items (i.e., corresponding to individual groups of advertising spots) of reservations, on an item-by-item basis, through use of the view site reservations application 800 described above.

Upon starting at step 902, the method of the approval center application 900 advances to step 904 where the server 200 causes the display of an “approval center” user interface on the display of the site owner's telecom device 116. The “approval center” user interface comprises a plurality of elements, including, but not limited to: a “site selection” drop-down list box which enables the site owner to select one of the site owner's sites for which the site owner desires to review and/or approve/decline advertisers; a “status” drop-down list box which enables the site owner to identify the category of advertisers for the selected site to be displayed for review (i.e., already “approved” advertisers, already “declined” or “rejected” advertisers, or “new” advertisers which have not been “approved” or “declined”); an “approval” button which enables the site owner to “approve” a selected advertiser; and, a “decline” button which enables the site owner to “decline” a selected advertiser. After causing the display of the “approval center” user interface on the site owner's telecom device 116, the server 200 continues operation at step 906 of the method where it receives a selection from the site owner, via the site owner's telecom device 116, of one of the above-described user interface elements.

At step 908, the server 200 determines whether the site owner selected the “site selection” drop-down list box. If so, the server 200 advances to step 910 where it causes the display of a drop-down list of the names of the site owner's sites which are available for selection by the site owner and allows the site owner to select a site. Then, the server 200, at step 912, receives the selection of a site by the site owner from the drop-down list and updates the “site selection” drop-down list box to reflect the name of the selected site. After updating the “site selection” drop-down list box, the server 200, at step 914, causes the display, on the site owner's telecom device 116, of a list of advertisers for the selected site which have the status currently displayed in the “status” drop-down list box. The list of advertisers, preferably, includes each advertiser on a separate row of the list and, for each advertiser, includes the advertiser's name, the contact person for the advertiser, and the phone number and email address of the contact person. The list of advertisers also, preferably, includes a selectable check box adjacent to each of the advertiser's names which is selectable by the site owner to select and, hence, identify a particular advertiser for subsequent approval or disapproval. Once the server 200 causes the display of the list of advertisers on the site owner's telecom device 116, the server 200 loops back to step 908 of the method to await further input from the site owner.

If the server 200 determines, at step 908, that the site owner did not select the “site selection” drop-down list box, the server 200 branches to step 916 of the method where it evaluates the site owner's input to decide if the site owner selected the “approval” button. If so, the server 200 changes the approval status of the selected advertiser for the site displayed in the “site selection” drop-down list box to reflect that the advertiser is approved by the site owner to make reservations for the presentation of advertisements on the site displayed in the “site selection” drop-down list box. The server 200 saves data representative of the modified approval status and then returns to step 908 of the method to await a future input or selection of an element of the user interface or an advertiser from the list of advertisers. If, at step 916, the server 200 decides that the site owner did not select the “approval” button, then the server 200 proceeds, in accordance with the method, to step 920 where it determines whether the site owner selected the “decline” button of the user interface. If so, the server 200, at step 922, changes the approval status of the selected advertiser for the site displayed in the “site selection” drop-down list box to reflect that the advertiser is not approved (i.e., “declined”, “rejected”, or otherwise, “disapproved”) by the site owner to make reservations for the presentation of advertisements on the site displayed in the “site selection” drop-down list box. The server 200 saves data representative of the modified approval status and then returns to step 908 of the method to await a future input or selection of an element of the user interface or an advertiser from the list of advertisers. If the server 200 determines, at step 920, that the site owner did not select the “decline” button, the server 200 advances to step 924 of the method.

At step 924, the server 200 once again considers the site owner's input and ascertains whether the site owner selected the “status” drop-down list box of the user interface. If not, the site owner selected an advertiser from the list of advertisers, thereby identifying a particular advertiser for subsequent approval or disapproval. In response to the site owner's selection of an advertiser, the server 200 marks the selected advertiser by placing a check mark in the check box associated with the selected advertiser in the displayed list of advertisers. If, alternatively, the server 200 ascertains, at step 924, that the site owner selected the “status” drop-down list box, the server 200 proceeds to step 926 of the method where it causes the display of a drop-down list of statuses (i.e., “approved”, “declined”, or “new”) on the site owner's telecom device 116 from which the site owner may choose. Then, at step 928, the server 200 receives a selection of a status from the “status” drop-down list and updates the status displayed in the drop-down list box to reflect the site owner's selection. In addition, at step 930, the server 200 refreshes the display of the list of advertisers on the site owner's telecom device 116 to show only those advertisers for the selected site having the status displayed in the “status” drop-down list box.

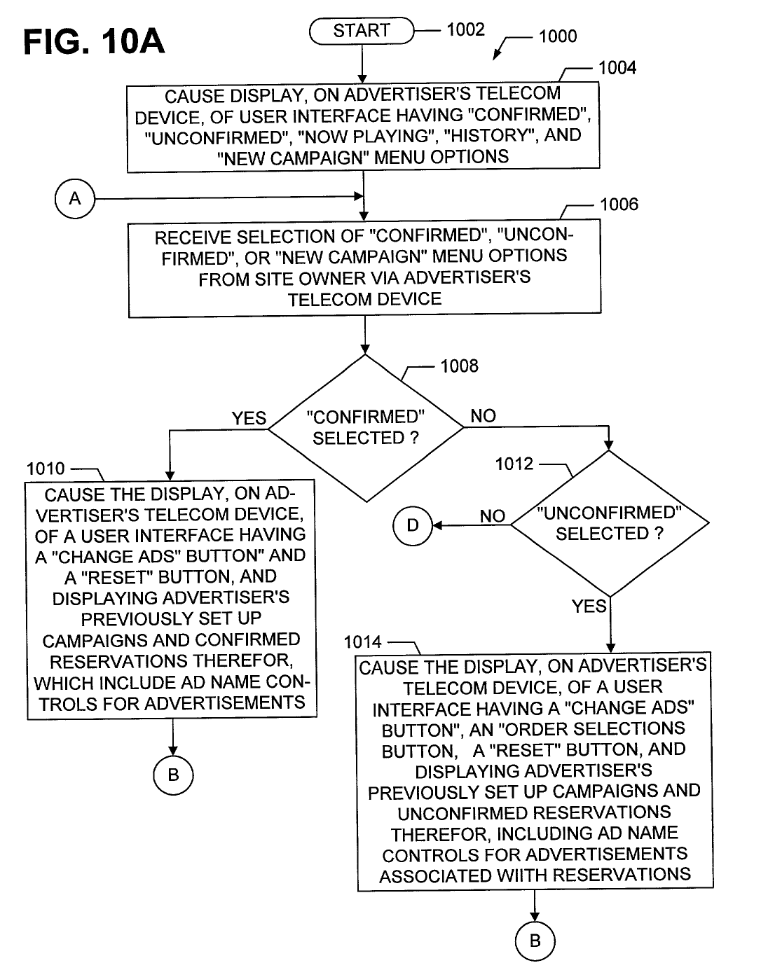

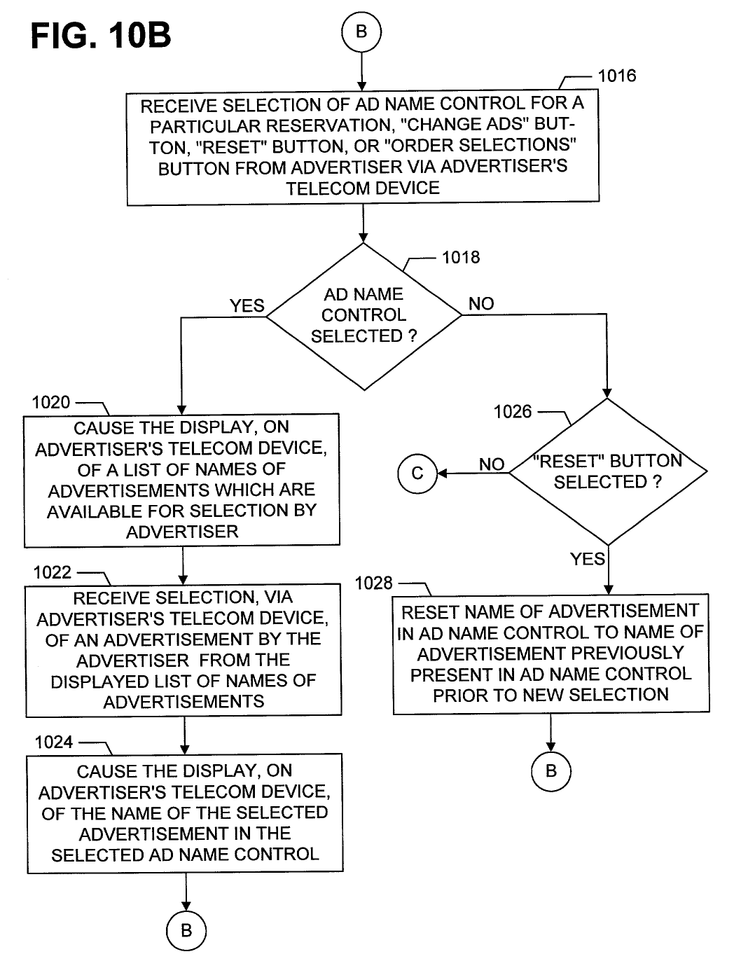

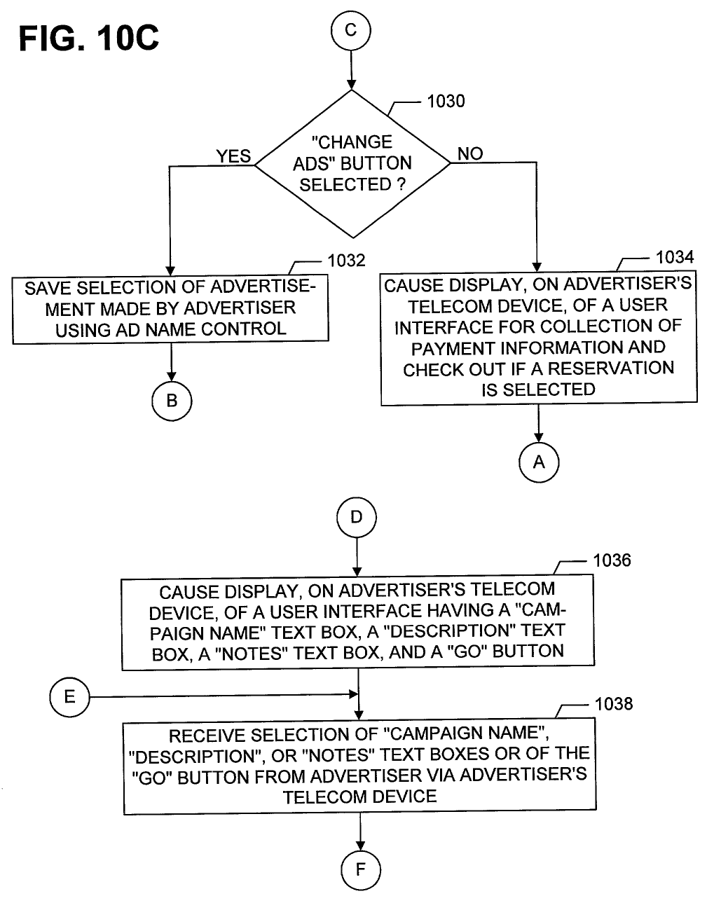

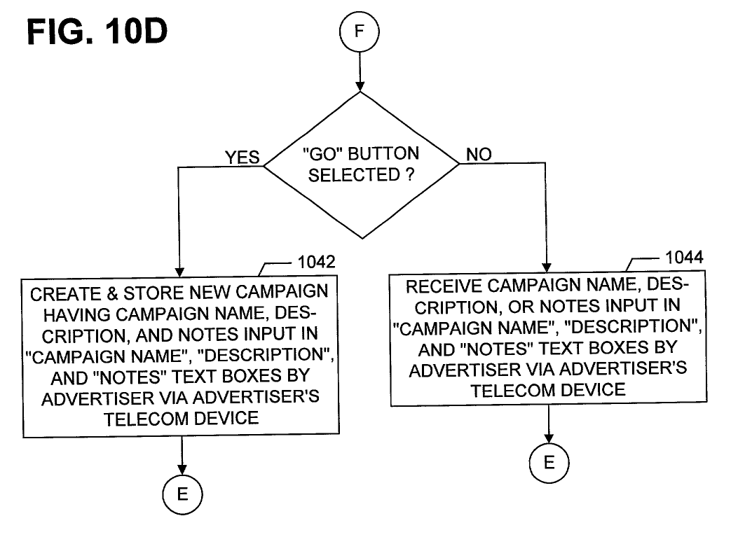

FIG. 10 displays a flowchart representation of a method utilized by the “campaigns” application 1000 (also referred to herein as the “campaigns process”) in accordance with the preferred embodiment of the present invention. The campaigns application 1000 enables an advertiser, through the advertiser's telecom device 120 and a pre-established telecommunication link with the server 200, to set-up and maintain a plurality of advertising campaigns with each campaign being capable of having a plurality of reservations for advertisements presented at a plurality of sites and at a plurality of dates and times. The campaign application 1000 also enables an advertiser to select and/or change advertisements associated with reservations and, prior to their expiration, confirm previously unconfirmed reservations. Although not described herein in detail, the campaign application 1000 further enables an advertiser to view those campaigns having reservations with selected dates before, after, or including the present date.

After starting at step 1002, the method of the campaigns application 1000 proceeds to step 1004 where the server 200 causes the display of a “campaigns” user interface on the display of the advertiser's telecom device 120. The “campaigns” user interface comprises a plurality of elements, including, but not limited to, “confirmed”, “unconfirmed”, “now playing”, “history”, and “new campaign” menu options. Upon causing the display of the “campaigns” user interface, the server 200 advances to step 1006 where the server 200 awaits and receives advertiser input, or a selection, of the “confirmed”, “unconfirmed”, or “new campaign” menu options via the advertiser's telecom device 120. Then, at step 1008, the server 200 determines whether the advertiser selected the “confirmed” menu option. If so, the server 200, at step 1010, causes the display, on the advertiser's telecom device 120, of a user interface having a plurality of elements, preferably, including a “change ads” button (i.e., which enables the advertiser, via its selection, to cause the saving and association of the advertisements having their names displayed in “ad name” controls, described below, with their respective reservations) and a “reset” button (i.e., which enables the advertiser, via its selection, to cause any changes made to the displayed selections of advertisements for reservations to be undone and the previous advertisement selections to be restored for the reservations). The server 200 also causes the display, on the advertiser's telecom device 120, of a list comprising the names of all of the advertiser's previously set-up campaigns and the confirmed reservations, if any, for each such campaign. Each reservation, preferably, includes an “ad name” control (i.e., a drop-down list box) which displays the name of the advertisement, if any, previously selected by the advertiser for association with the reservation and which enables the advertiser to initially select an advertisement, or change a previous selection of an advertisement, for the reservation from the advertiser's ad portfolio. Note, however, that the advertiser may not have already selected, or identified, an advertisement to be presented during the reservation's reserved hour-long time segment, and, hence, the “ad name” control may be blank or state “no ad selected”. After causing the display of the list of campaigns, the server 200 moves forward to step 1016 of the method described below.

If, at step 1008, the server 200 determines that the advertiser did not select the “confirmed” menu option, the server 200 advances to step 1012 of the method where it ascertains whether the advertiser selected the “unconfirmed” menu option from the “campaigns” user interface. If not, the server 200 proceeds to step 1036 of the method described below to create a new campaign. If so, at step 1014, the server 200 causes the display of a user interface, on the advertiser's telecom device 120, which comprises: a “change ads” button which enables to the advertiser, via its selection, to cause the saving and association of the advertisements having their names displayed in “ad name” controls, described below, with their respective reservations; a “reset” button which enables the advertiser, via its selection, to cause any changes made to the displayed selections of advertisements for reservations to be undone and the previous advertisement selections to be restored for the reservations; and, an “order selections” button which enables the advertiser to “order” (i.e., submit payment for) the unconfirmed reservations which the advertiser selects or identifies as described below. Also, at step 1014, the server 200 causes the display of a list comprising the names of all of the advertiser's previously set-up campaigns and the unconfirmed reservations, if any, for each such campaign. Each unconfirmed reservation, preferably, includes an “ad name” control (i.e., a drop-down list box) which displays the name of the advertisement, if any, previously selected by the advertiser for association with the reservation and which enables the advertiser to initially select and associate an advertisement with, or change a previous selection of an advertisement for, the reservation from the advertiser's ad portfolio. Note, however, that the advertiser may not have already selected, or identified, an advertisement to be presented during the reservation's reserved hour-long time segment, and, hence, the “ad name” control may be blank or state “no ad selected”. Each unconfirmed reservation of the list also, preferably, includes a “check” box which enables the advertiser to select, or deselect, an unconfirmed reservation for subsequent ordering. After causing the display of the list of campaigns, the server 200 moves forward to step 1016 of the method described below.

At step 1016, the server 200 awaits and receives a selection of an “ad name” control for a particular reservation, the “change ads” button, the “reset” button, the “order selections” button, or a “check” box of an unconfirmed reservation displayed on the advertiser's telecom device 120. While not displayed in FIG. 10A-10D, if a “check” box is selected, the server 200 toggles the selection status of the corresponding unconfirmed reservation from unselected (i.e., as indicated by the absence of a check mark in the “check” box) to selected (i.e., as indicated by the presence of a check mark in the “check” box), or from selected to unselected, as the case may be. Continuing at step 1018 of the method, the server 200 decides whether an “ad name” control has been selected by the advertiser. If so, the server 200, at step 1020, causes the display, on the advertiser's telecom device 120, of a drop-down list of names of advertisements previously created and stored in the advertisers ad portfolio for selection by the advertiser. Then, at step 1022, the server 200 receives from the advertiser, via the advertiser's telecom device 120, a selection, or identification, of an advertisement name and, hence, an advertisement, from the drop-down list of advertisement names to associate with, or assign to, the respective reservation corresponding to the selected “ad name” control. Upon receiving a selection of an advertisement name, the server 200 causes, at step 1024, the display of the name of the selected advertisement in the selected “ad name” control. The server 200 then branches back to step 1016 of the method to again await for and receive a selection from the advertiser.

If, alternatively, the server 200 decides, at step 1018, that the advertiser did not select an “ad name” control, the server 200 moves forward to step 1026 of the method where it ascertains whether the advertiser selected the “reset” button. If so, at step 1028, the server 200 resets the names of the advertisements displayed in the “ad name” controls to those names of advertisements previously present, or displayed, in the “ad name” controls prior to the most recent selection of the “change ads” button. Then, the server 200 loops back to step 1016 of the method to once again await and receive a selection from the advertiser. If, at step 1026, the server 200 ascertained that the “reset” button was not selected by the advertiser, the server 200 determines, at step 1030, whether the “change ads” button was selected by the advertiser. If so, the server 200 causes the saving of the advertisement selections (i.e., from the advertiser's ad portfolio) currently identified by the advertisement names displayed in the “ad name” controls and the associating of the same advertisement selections with the respective reservations corresponding to the “ad name” controls. The server 200 subsequently returns to step 1016 of the method to await and receive a further selection by the advertiser.

If the server 200 determines, at step 1030, that the “change ads” button was not selected by the advertiser, the advertiser selected the “order selections” button and desires to “order”, or confirm, the reservations that the advertiser selected from the list of previously unconfirmed reservations. Therefore, the server 200 causes, at step 1034, the display of a user interface (described below) for collection of payment information (i.e., whether the advertiser will pay by electronic check or credit card and, if by credit card, an identification of the credit card account to which the cost of the ordered reservations will be charged). Upon receiving appropriate and/or acceptable payment information and a subsequent selection of a “check-out” button (described below) by the advertiser, the server 200 completes the ordering process by causing the debit of the advertiser's identified electronic check or credit card account for the cost of the ordered reservation(s) and sets the confirmed/unconfirmed status of the ordered reservation(s) to “confirmed”. Then, the server 200 branches back to step 1006 of the method to await and receive a selection by the advertiser.

At step 1036, the server 200 causes the display, on the advertiser's telecom device 120, of a user interface including a “campaign name” text box (i.e., for receipt of a name for the new campaign being created by the advertiser), a “description” text box (i.e., for receipt of a description of the new campaign being created by the advertiser), a “notes” text box (i.e., for other information, or notes, relevant to the new campaign being created by the advertiser), and a “go” button (i.e., to enable the advertiser to instruct the server 200 to create a new campaign with the name, description, and notes provided via the previously identified text boxes). Upon causing the display of the user interface, the server 200 moves forward to step 1038 of the method where it awaits and receives selection of the “campaign name”, “description”, or “notes” text boxes or of the “go” button of the user interface.

Continuing at step 1040, the server 200 determines whether the “go” button was selected by the advertiser. If not, the advertiser selected one of the “campaign name”, “description”, or “notes” text boxes and the server 200 respectively receives input from the advertiser of a campaign name, associated description, or associated notes for the new campaign being created by the advertiser. Then, the server 200 loops back to step 1038 to await and receive further input from the advertiser via the advertiser's telecom device 120. If the server 200 determined, at step 1040, that the advertiser selected the “go” button, the server 200 advances to step 1042 where it creates a new campaign, associates the new campaign with the advertiser, and saves and associates the campaign name, description, and notes input by the advertiser in the “campaign name”, “description”, and “notes” text boxes with the new campaign. Once the new campaign has been created, the server 200 branches back to step 1038 to await and receive another selection from the advertiser.

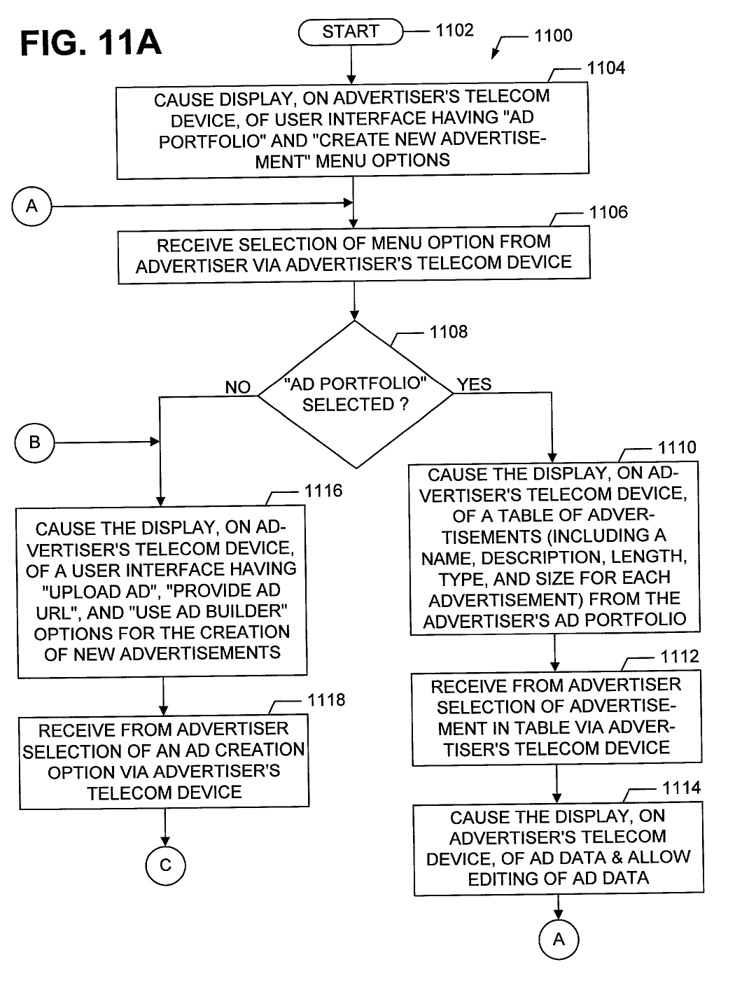

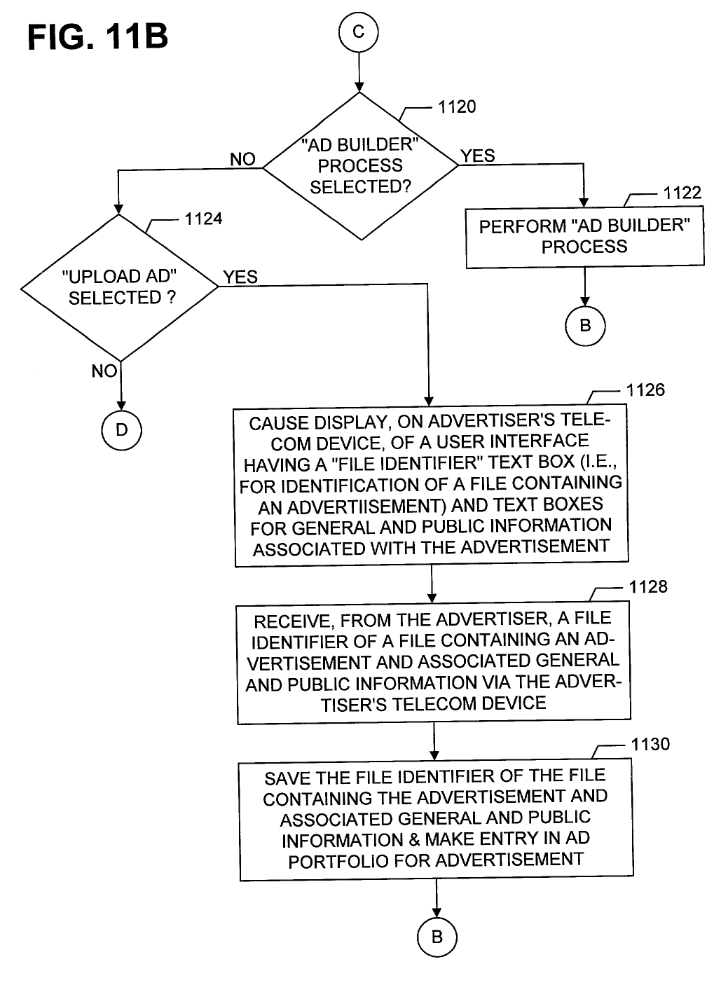

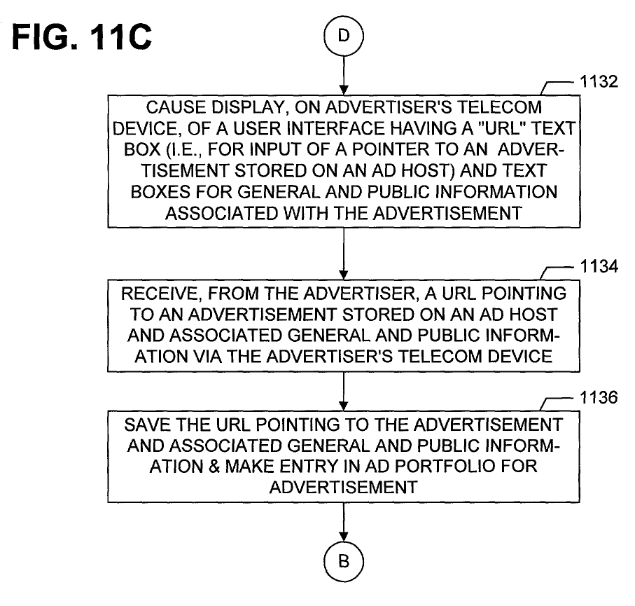

FIG. 11 illustrates a flowchart representation of a method utilized by the “advertisements” application 1100 (also referred to herein as the “advertisements process”) in accordance with the preferred embodiment of the present invention. The advertisements application 1100 enables an advertiser, through the advertiser's telecom device 120 and a pre-established telecommunication link with the server 200, to manage advertisements in the advertiser's ad portfolio and to add new advertisements thereto. After starting at step 1102, the method of the advertisements application 1100 proceeds to step 1104 where the server 200 causes the display of an “advertisements” user interface on the display of the advertiser's telecom device 120. The “advertisements” user interface comprises a plurality of menu options, including, but not limited to, an “ad portfolio” option and a “create new advertisement” option. Upon causing the display of the “advertisements” user interface, the server 200 advances to step 1106 where the server 200 awaits and receives the advertiser's selection of a menu option from the “advertisements” user interface via the advertiser's telecom device 120.

Proceeding to step 1108, the server 200 determines whether the advertiser selected the “ad portfolio” menu option. If so, at step 1110, the server 200 causes the display, on the advertiser's telecom device 120, of a table of advertisements from the advertiser's ad portfolio stored on the server 200. Each advertisement displayed in the table, preferably, includes a name, description, length (i.e., 15 seconds, 30 seconds, or 60 seconds), type (i.e., the type, or format, of the file containing the advertisement), and size (i.e., a size of the file containing the advertisement) for the respective advertisement. Each advertisement also, preferably, includes a “check” box adjacent the name of the advertisement. Then, at step 1112, the server 200 receives the selection of an advertisement from the advertiser through the advertiser's telecom device 120. Note that if a “check” box is selected by the advertiser, the server 200 toggles the selection status of the corresponding advertisement from unselected (i.e., as indicated by the absence of a check mark in the “check” box) to selected (i.e., as indicated by the presence of a check mark in the “check” box), or from selected to unselected, as the case may be.

Upon receipt of the selection of an advertisement from the table of advertisements, the server 200, at step 1114, causes the display of ad data (i.e., data associated with the selected advertisement when the advertisement was added to the advertiser's ad portfolio as described below) on the advertiser's telecom device 120. Preferably, the ad data comprises “public” information and “general” information for the selected advertisement. The “public” information, generally, includes advertiser modifiable information such as, for example, the ad's name (i.e., which is displayed in “ad name” controls and/or “ad name” drop-down lists and in the table of advertisements described above), the advertiser's name, a referral link (i.e., an Internet link to the advertiser's website), the name of the ad creator, and non-modifiable information such as, for example, the date and time of the ad's creation and the date and time of the last modification to the advertisement. The “general” information, preferably, includes advertiser modifiable information such as, for example, a file identifier (i.e., device, directory, and file name data or an Internet address identifying the storage location of the advertisement), a description of the advertisement, and keywords relevant to the advertisement, and non-modifiable information such as, for example, the length of the advertisement (i.e., 15 seconds, 30 seconds, or 60 seconds), the size of the file storing the advertisement (i.e., a number of bytes of computer storage space), and the type of the file storing the advertisement. In addition to the causing the display of the ad data, the server 200 causes the display of “save changes”, “delete”, and “cancel” buttons and enables the advertiser to edit the modifiable “public” and “general” information and to cause saving or cancellation of the changes through respective selection of the “save changes” and “cancel” buttons. The “delete” button enables the advertiser to cause, by its selection, the server 200 to delete the selected advertisement having the displayed “public” and “general” information. After enabling the viewing, modification, and saving of “public” and “general” information for the selected advertisement, or deletion thereof, the server 200 returns to step 1106 of the method where it once again awaits and receives a menu option selection from the advertiser.

If, at step 1108, the server 200 determines that the advertiser did not select the “ad portfolio” menu option, the advertiser selected the “create new advertisement” menu option and the server 200 causes, at step 1116, the display of a user interface on the advertiser's telecom device 120 having ad creation options, including, an “upload ad” option (i.e., the selection of which enables the advertiser to upload an advertisement from the advertiser's telecom device 120 or another computing device), a “provide ad URL” option (i.e., the selection of which enables the advertiser to provide a URL pointing to an advertisement on an ad host accessible via the Internet), and a “use ad builder” option (i.e., the selection of which enables the advertiser to create a new advertisement using the “ad builder” process described below). Then, at step 1118, the server 200 receives the selection of an ad creation option from the advertiser via the advertiser's telecom device 120.

Continuing at step 1120 of the method, the server 200 decides whether the advertiser selected the “use ad builder” ad creation option. If so, the server 200 performs the “ad builder” process 1200, described below, to create a new advertisement and returns to step 1116 thereafter to cause the display of the ad creation options. If not, the server 200 advances to step 1124 where it ascertains whether the advertiser selected the “upload ad” option. If the server 200 ascertains that the advertiser selected the “upload ad” option, the server 200 causes the display, on the advertiser's telecom device 120, of a user interface comprising a “file identifier” text box (i.e., for identification of the path to and file name for a file containing an advertisement, already created by the advertiser, for uploading to the server 200) and other text boxes for the input of “public” and “general” information as described above. Next, the server 200, at step 1128, receives the input of a “file identifier” and “public” and “general” information for the advertisement from the advertiser via the advertiser's telecom device 120 and the respective “file identifier” and other text boxes. After receiving the “file identifier” , “public” information, and “general” information, the server 200 uploads the identified file containing the new advertisement for addition to the advertiser's portfolio at step 1130. The server 200 saves the uploaded file at the server 200, associates and saves the “public” and “general” information related thereto at the server 200, and creates an entry in the advertiser's ad portfolio for the uploaded advertisement and related “public” and “general” information. Next, the server 200 branches back to step 1116 described above.

If the server 200 ascertains, at step 1124, that the advertiser did not select the “upload ad” option, the advertiser selected the “provide ad URL” and the server 200 causes the display, at step 1132, of a user interface on the advertiser's telecom device 120 having a “URL” text box (i.e., for input by the advertiser of a pointer to an advertisement already created and stored on an ad host accessible by the server 200 through the Internet) and text boxes for “public” and “general” information as described above. Then, at step 1134, the server 200 receives from the advertiser, via the advertiser's telecom device 120 and the “URL” text box, the input of a URL pointing to an already existing advertisement. The server 200 also receives “public” and “general” information from the advertiser, via the advertiser's telecom device 120 and the text boxes for “public” and “general” information. Advancing to step 1136, the server 200 saves the URL, for the advertisement to be added to the advertiser's ad portfolio, at the server 200. The server 200 additionally associates the input “public” and “general” information with the advertisement, saves the “public” and “general” information at the server 200, and creates an entry in the advertiser's ad portfolio for the advertisement and related “public” and “general” information. After creating the entry in the ad portfolio, the server 200 loops back to step 1116 where it again causes the display of the user interface having ad creation options on the display of the advertiser's telecom device 120.

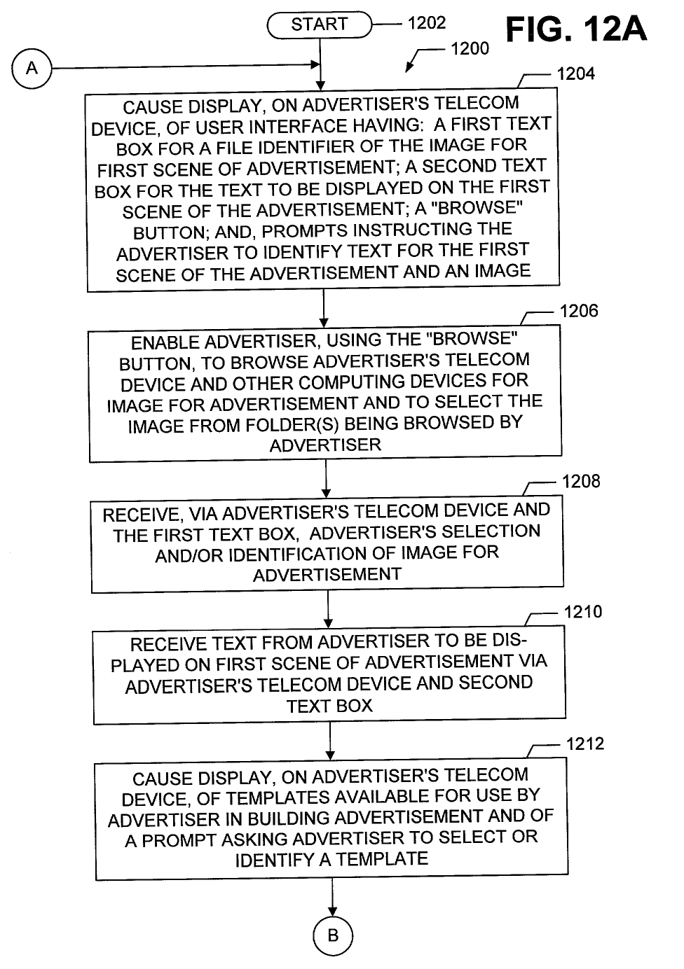

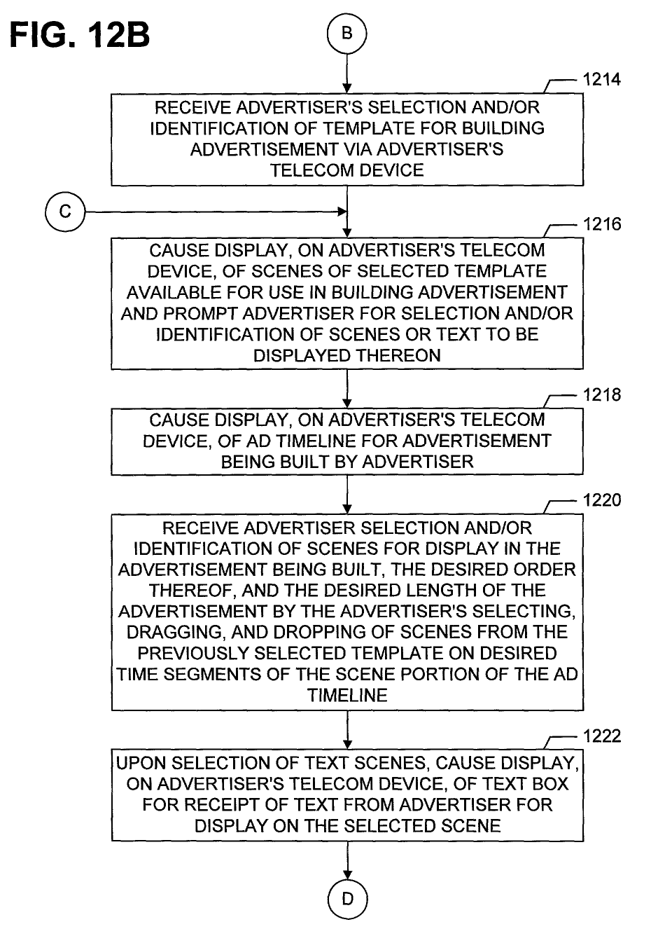

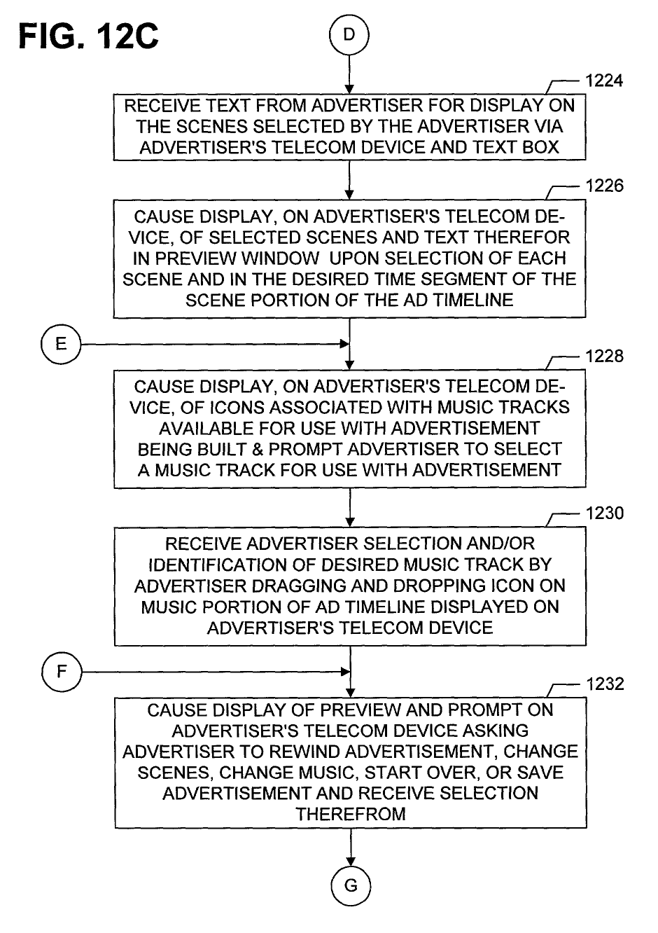

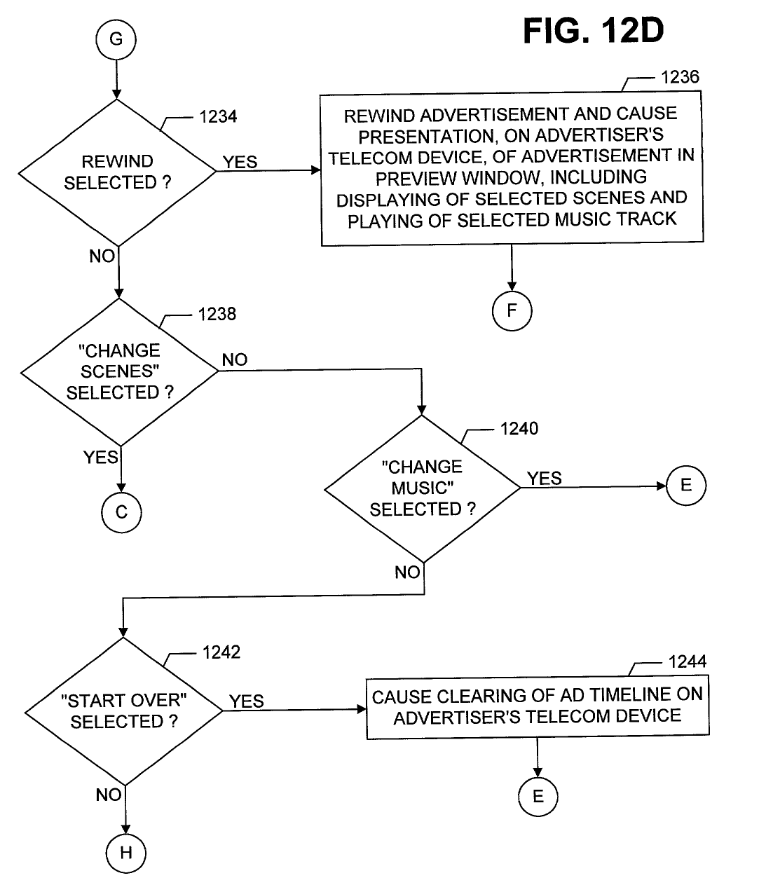

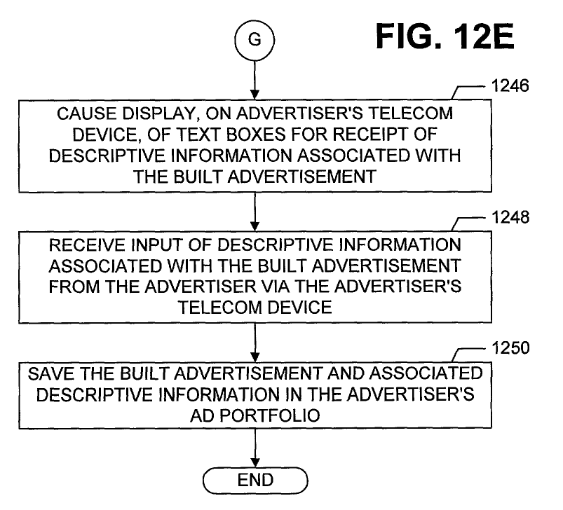

FIG. 12 depicts a flowchart representation of a method utilized by the “ad builder” application 1200 (also referred to herein as the “ad builder process”) in accordance with the preferred embodiment of the present invention. The ad builder application 1200 creates, or builds, a new advertisement including a plurality of scenes and a music track, in response to inputs and/or selections received from the advertiser via the advertiser's telecom device 120 and a pre-established telecommunication link with the server 200. After starting at step 1202, the method of the ad builder application 1200 proceeds to step 1204 where the server 200 causes the display, on the advertiser's telecom device 120, of a user interface comprising a plurality of elements, including, but not limited to: a first text box for a file identifier of an image (i.e., typically, a logo) for display, in accordance with the template described below, on various scenes of the advertisement being created; a second text box for the text to be displayed on the first scene of the advertisement; a “browse” button which, when selected by the advertiser, causes the server 200 to display lists of files on selected computing devices so that the advertiser may select, or determine the file identifier for, a file containing the image; and, prompts instructing the advertiser to input a file identifier in the first text box, or select a file identifier through use of the “browse” button, for the file containing the image.

Upon causing the display of the user interface, the server 200 moves forward to step 1206 of the method where it displays, in response to the advertiser's selection of the “browse” button, file identifiers (i.e., path designations including device identifiers, directory identifiers, and file names) corresponding to files stored on the advertiser's telecom device 120 and other computing devices, if accessible, so that the advertiser may select a file which contains the image that the advertiser desires to use (i.e., typically, as a logo) on various scenes of the advertisement. Then, at step 1208, the server 200 receives a selection or identification of a file identifier for image from the advertiser, either by selection of the file identifier through the advertiser's use of the “browse” button or by the advertiser's input of the file identifier via the first text box of the user interface. Next, at step 1210, the server 200 receives text from the advertiser, via the second text box of the user interface and the advertiser's telecom device 120, to be displayed on the first scene of the advertisement.

The server 200, proceeding to step 1212 of the method, causes the display, on the advertiser's telecom device 120, of a window including a plurality of templates available for use in creating the advertisement. Each template comprises and groups together a plurality of scenes and music tracks which are selectable by the advertiser during creation of the advertisement. The plurality of scenes may include image scenes (i.e., having no text thereon) or text scenes. The server 200, at step 1212, also displays a prompt instructing the advertiser to select or identify a template for use. After prompting the advertiser, the server 200 receives the advertiser's selection and/or identification of a template from the advertiser via the advertiser's telecom device 120 at step 1214. Then, at step 1216, the server 200 causes the display, on the advertiser's telecom device 120, of scenes from the selected template which are available for inclusion in the advertisement being built and prompts the advertiser to select and/or identify a scene and, if appropriate, to input text to be displayed in conjunction with (and, preferably, superimposed upon) the selected, or identified, scene.

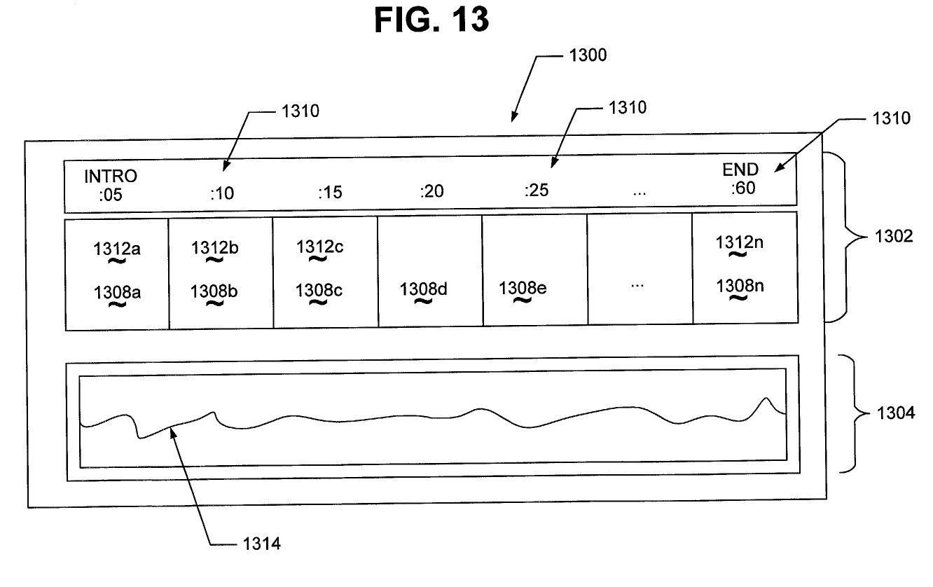

Continuing at step 1218 of the method, the server 200 causes the display, on the advertiser's telecom device 120, of an “ad timeline” 1300 for the advertisement being built. FIG. 13 displays an ad timeline 1300 in accordance with the preferred embodiment of the present invention. As seen in FIG. 13, the ad timeline 1300, preferably, comprises a first portion 1302 which displays scenes selected for the advertisement and a second portion 1304 which displays a graphical representation of a music track selected for the advertisement. During presentation of the advertisement at a site owner's site selected by the advertiser, the selected scenes are displayed while the selected music track is played. The first portion 1302 of the ad timeline 1300 includes, preferably, an elongated rectangular region 1306 which is subdivided into a plurality of segments 1308 (i.e., where alphabetic subscripts indicated different segments), with each segment representing, preferably, five seconds of the advertisement's total duration. The first, leftmost, segment 1308a of the ad timeline 1300 corresponds to and is associated with the first scene of the advertisement (i.e., which is selected by the advertiser as described above) and the last, rightmost, segment 1308n of the ad timeline 1300 corresponds to and is associated with the last scene of the advertisement. The segments 1300 between the first and last segments 1300a, 1300b of the ad timeline 1300 correspond to and are associated with individual scenes of the advertisement that are displayed (i.e., when the advertisement is presented at a selected site owner's site), for , preferably, five seconds each in the order defined by starting at the first segment 1308a and moving to the right in the direction of the last segment 1308n.

The ad timeline 1300 also comprises a series of time indicators 1310 which are displayed, preferably, above each of the segments 1300 of the first portion 1302. The time indicators 1310 display the “running” time of the advertisement starting at the first, leftmost, segment 1308a (i.e., corresponding to the first scene) and increasing in the direction of the last, rightmost, segment 1308n. The time indicators 1310 assist the advertiser in determining where to place, or position, a selected scene relative to other scenes of the advertisement and assist the advertiser in creating advertisements that have a duration shorter, and, hence, a number of segments 1308 less than the total number of segments 1308 which are displayed for use by the advertiser (i.e., the ad timeline 1300 displays enough segments 1308 for the creation of a full sixty second advertisement, yet the advertiser may desire to create only a fifteen or thirty second advertisement). It should be understood that the scope of the present invention includes various other apparatuses for and methods of portioning an advertisement into time segments with which individual scenes of the advertisement are associated. It should also be understood that the scope of the present invention includes ad timelines having time segments of other durations and time segments having variable durations relative to one another. It should be further understood that the scope of the present invention includes ad timelines having second portions for music tracks which are subdivided into segments so that different music tracks may be associated with the different segments.

Proceeding with the ad builder process 1200 displayed in FIGS. 12A-12E, the server 200, at step 1220, receives a selection and/or identification of scenes for the advertisement being built, the desired order of the scenes, and the desired length of the advertisement (i.e., determined by the number of scenes selected by the advertiser) by enabling the advertiser's selecting, dragging, and dropping of image or text scenes 1312 from the previously selected template onto desired, respective time segments 1308 of the first, or scene, portion 1302 of the ad timeline 1300 (i.e., the individually selected and ordered scenes 1312 are identified by different alphabetic subscripts in FIG. 13). Note that, while not described in FIGS. 12A-12E, if the advertiser desires to remove a previously selected scene 1312 from the advertisement, the server 200 enables the advertiser to do so by receiving selection of the scene 1312 for removal and movement (i.e., by the advertiser's dragging and dropping) of the selected scene 1312 onto a “trash can” element of the user interface. Upon the receipt of the selection of each scene 1312 from the advertiser through the advertiser's telecom device 120, if the respectively selected scene is a text scene, the server 200 causes, at step 1222, the display thereon of a text box for receipt of text from the advertiser to be displayed in conjunction with the respectively selected scene 1312 of the advertisement (i.e., preferably, the text is superimposed atop the selected scene 1312 when the advertisement is presented at a site owner's site). At step 1224, the server 200 receives text from the advertiser, via the advertiser's telecom device 120, for display with the selected text scenes 1312 of the advertisement. It should be understood that the text associated with and input for each selected text scene 1312 may be the same or may be different at the advertiser's discretion. As the selection of scenes 1312 and input of associated, respective text are received, the server 200 causes, as indicated at step 1226, the display of the selected scenes 1312 and corresponding text in a preview window of the user interface and on the ad timeline 1300.

At step 1228 of the method, the server 200 causes the display of icons, or identifiers, in a music selection window on the advertiser's telecom device 120 which are individually and uniquely associated with respective music tracks available for selection by the advertiser for inclusion in the advertisement being built. The server 200 also causes the display, on the advertiser's telecom device 120, of a prompt which requests that the advertiser select a music track for the advertisement. Next, at step 1230, the server 200 receives, via the advertiser's telecom device 120, the selection of a desired music track by the advertiser's dragging and dropping the icon corresponding to the desired music track 1314 on the second portion 1304 of the ad timeline 1300.

Advancing to step 1232 of the method, the server 200 causes presentation of the advertisement in a preview window of the user interface displayed on the advertiser's telecom device 120. During the presentation, the scenes 1312 of the advertisement are displayed and the music track 1314 of the advertisement is played back to the advertiser. The server 200 also causes display of a “rewind advertisement” button, a “change scenes” button, a “change music” button, a “start over button”, and a “save advertisement” button on the user interface displayed on the advertiser's telecom device 120. Additionally, the server 200 causes the display of a prompt, on the user interface, asking the advertiser to select a button. Subsequently, the server 200 receives the selection of a button from the advertiser via the advertiser's telecom device 120. At step 1234, the server 200 determines whether the advertiser selected the “rewind” button. If so, at step 1236, the server 200 causes the rewinding and presentation of the advertisement in the preview window of the user interface displayed on the advertiser's telecom device 120. Then, the server 200 loops back to step 1232 of the method to await and receive another button selection from the advertiser.

If, at step 1234, the server 200 determines that the advertiser did not select the “rewind” button, the server 200 proceeds to step 1238 of the method where it decides whether the advertiser selected the “change scenes” button, thereby indicating the advertiser's desire to change one or more of the previously selected scenes or input text of the advertisement. If so, the server 200 branches back to step 1216 where it causes the display of scenes for selection by the advertiser as described above. If not, the server 200 moves to step 1240 of the method where it ascertains whether the advertiser selected the “change music” button, thereby indicating the advertiser's desire to change the music previously selected for the advertisement. If, at step 1240, the server 200 decides that the advertiser selected the “change music” button, the server 200 loops back to step 1228 of the method to enable the advertiser to select a new music track for the advertisement. If, alternatively, the server 200 decides, at step 1240, that the advertiser did not select the “change music” button, the server 200, at step 1242, determines whether the advertiser selected the “start over” button (i.e., thereby indicating the advertiser's desire to start completely over in order to build a new advertisement). If so, the server 200 causes, at step 1244, clearing of the first and second portions 1302, 1304 of the ad timeline 1300 displayed on the advertiser's telecom device 120 and branches back to step 1204 to start the ad builder process 1200 over. If not, the advertiser selected the “save advertisement” button and the server 200 advances to step 1246 of the method.

At step 1246, the server 200 causes the display, on the advertiser's telecom device 120, of text boxes for the receipt of descriptive information to be associated with the advertisement, including “public” and “general” information similar to that described above in relation to the advertisements application 1100. Next, at step 1248, the server 200 receives input of the descriptive information from the advertiser via the advertiser's telecom device 120. Then, at step 1250, the server 200 saves the built advertisement, associates the descriptive information with the built advertisement, and makes an entry in the advertiser's portfolio for the built advertisement. Subsequently, at step 1252, the server 200 returns to operation in accordance with the advertisements application 1100 and displays the ad creation options to the advertiser as described above.

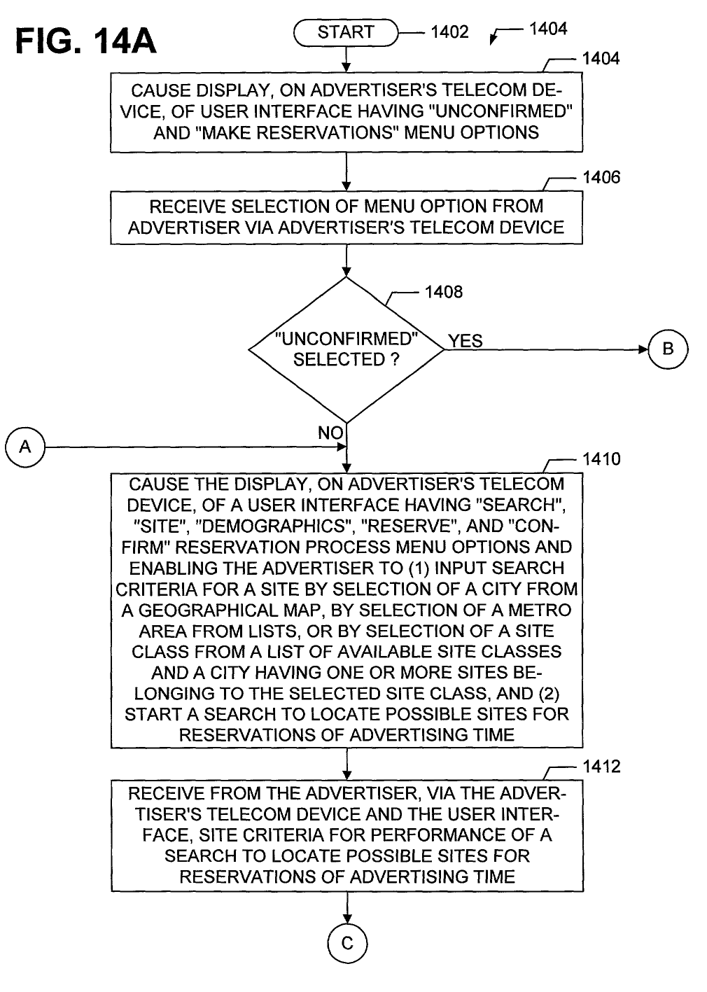

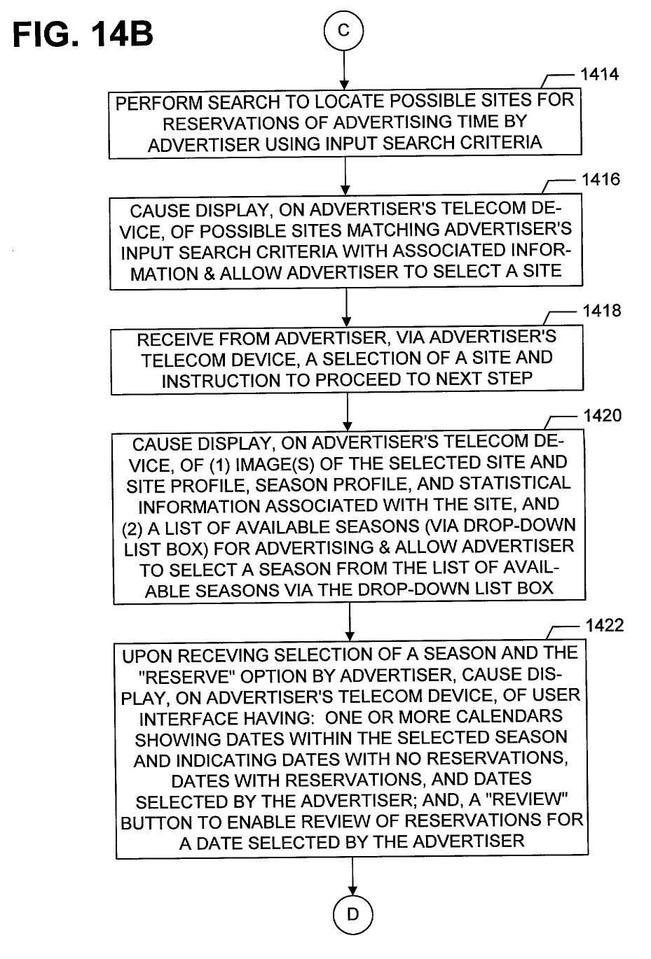

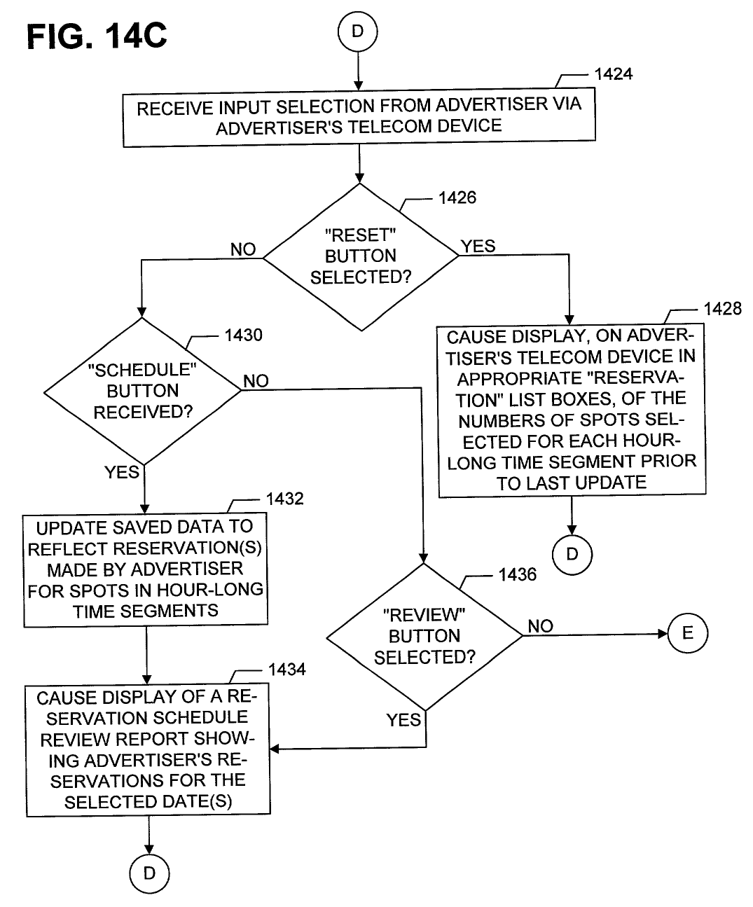

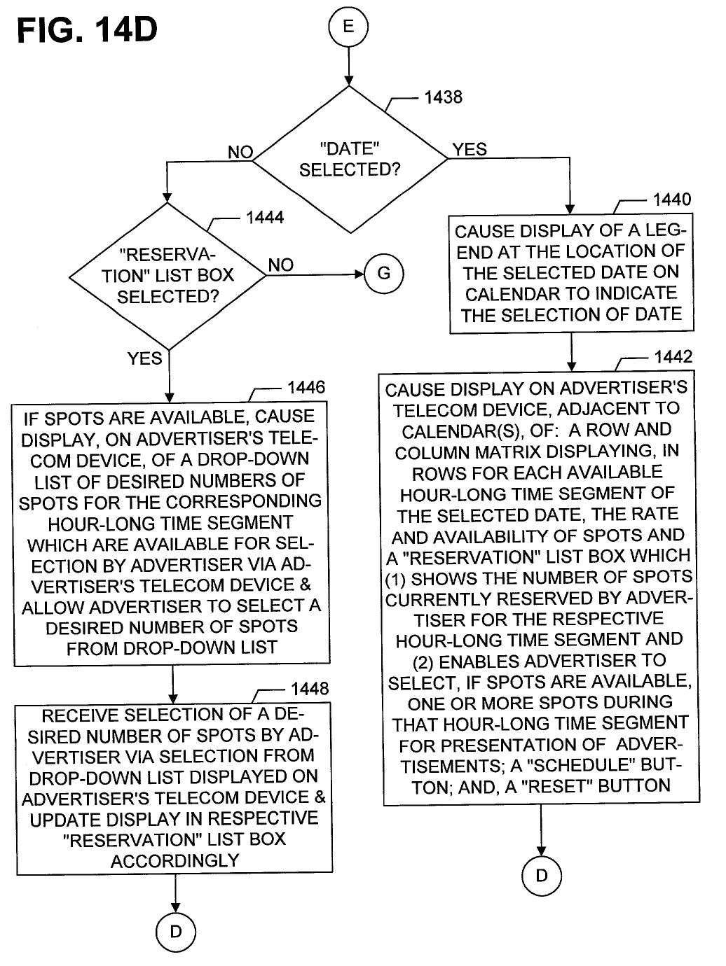

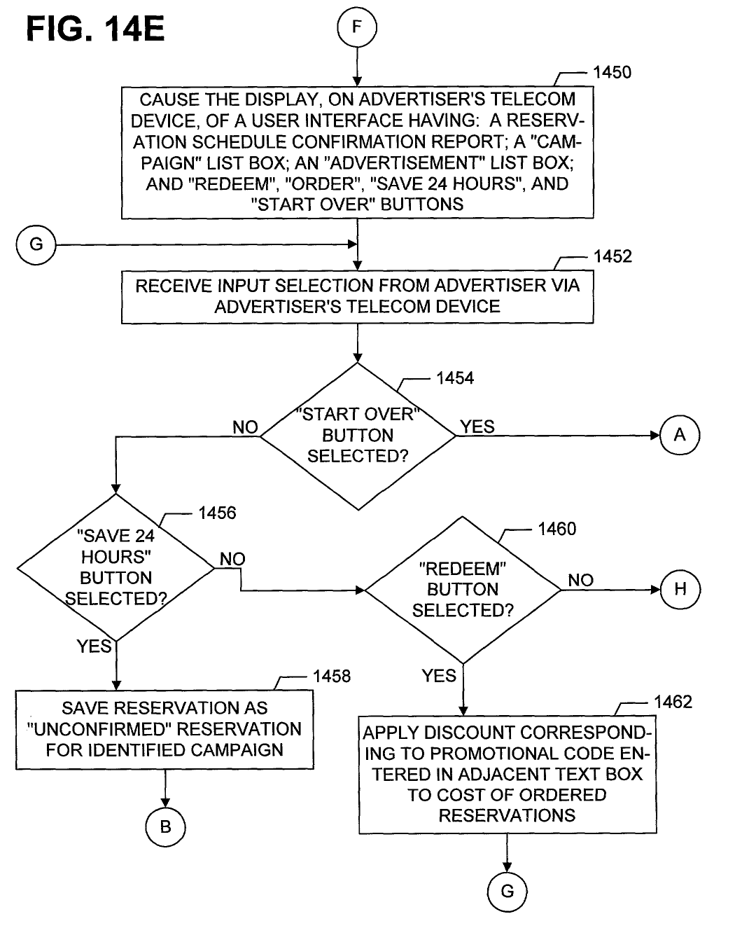

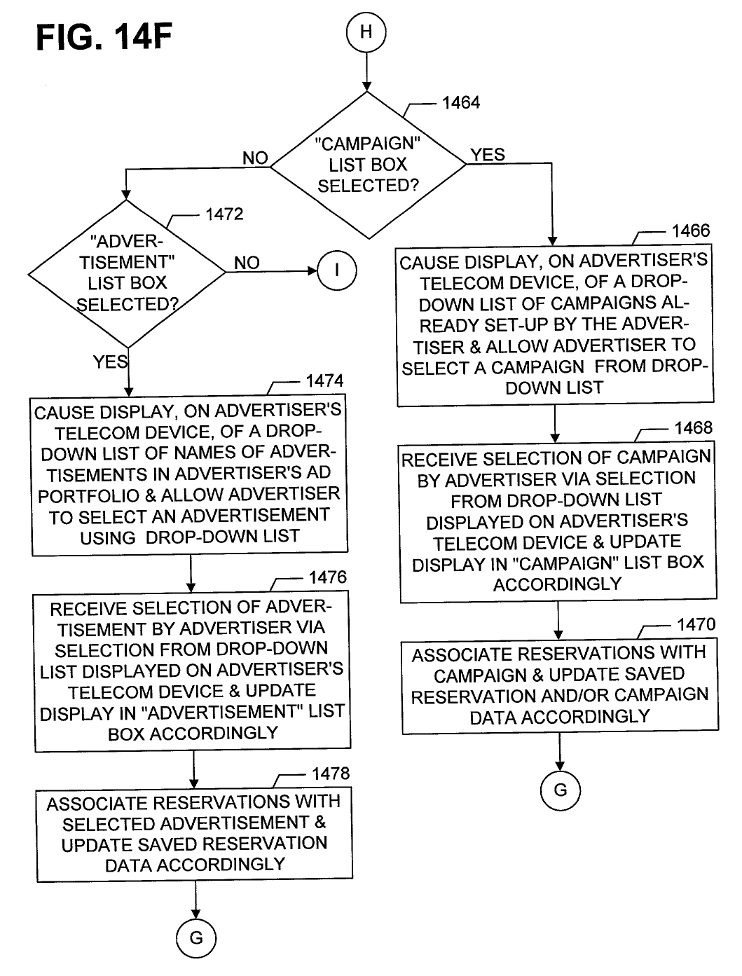

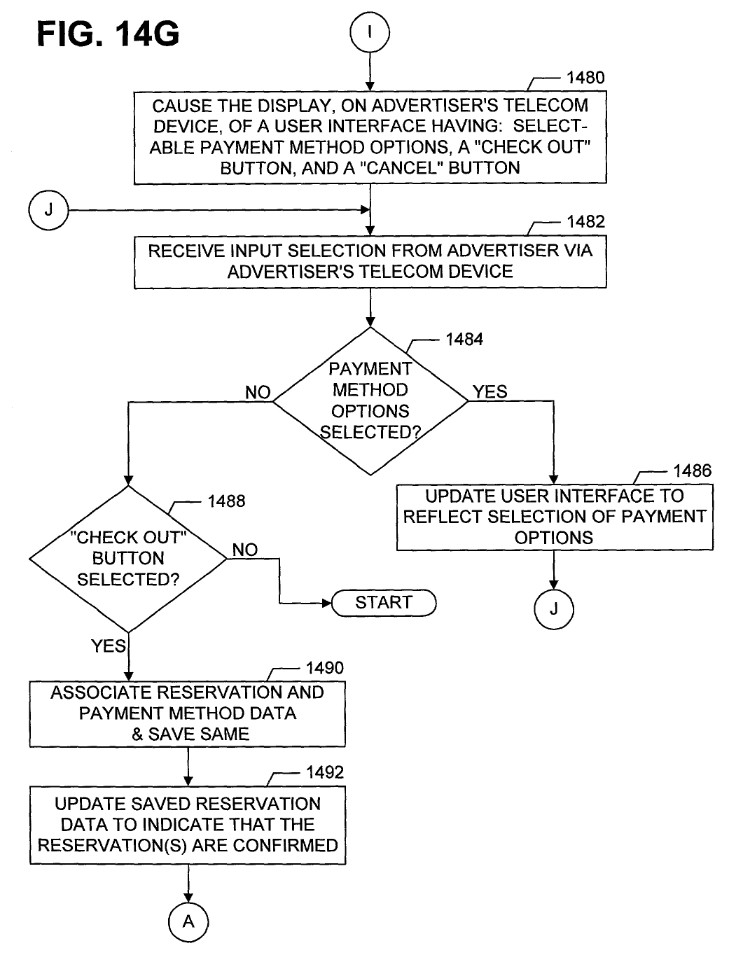

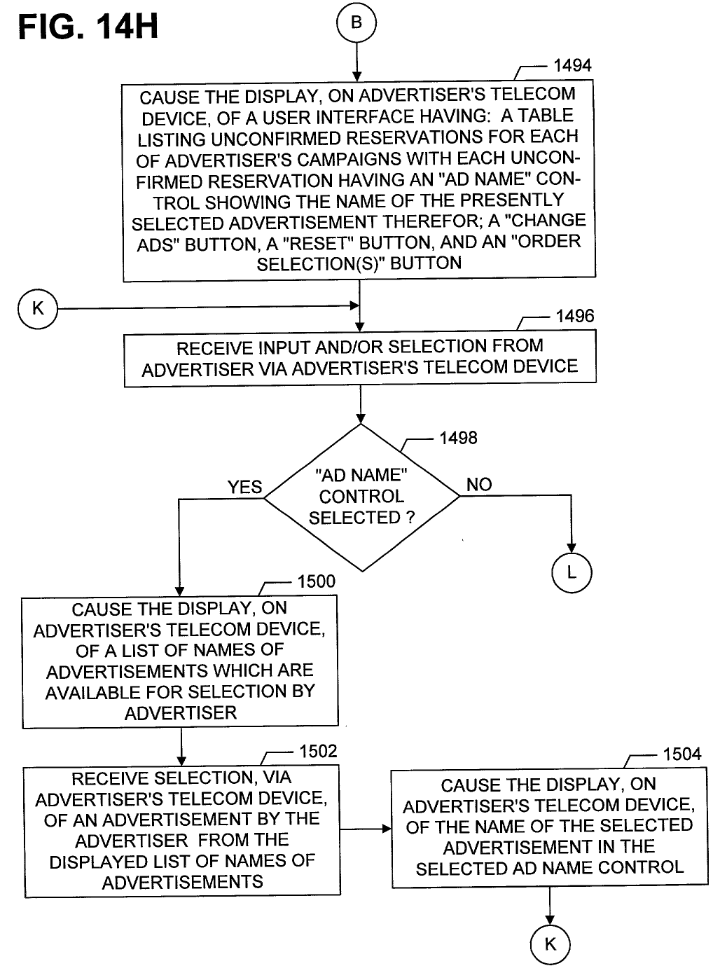

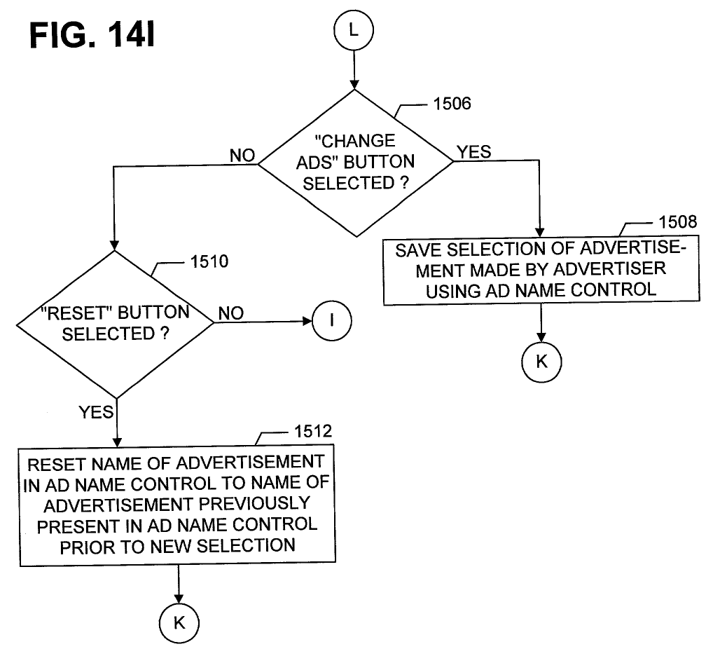

FIG. 14 displays a flowchart representation of a method of the “reservations” application 1400 (also referred to herein as the “reservations process”) in accordance with the preferred embodiment of the present invention. The reservations application 1400, performs a variety of tasks in response to advertiser input, including, but not limited to, the creation of new advertising reservations for advertisers and their advertisements in the system database 306 and the changing of the “confirmed/unconfirmed” status thereof from “unconfirmed” to “confirmed” . After starting at step 1402, the method of the reservations application 1400 proceeds to step 1404 where the server 200 causes the display, on the advertiser's telecom device 120, of a user interface having “unconfirmed” and “make reservation” menu options. Then, at step 1406, the server 200 awaits and receives the selection of a menu option from the advertiser, via the advertiser's telecom device 120. Next, at step 1408, the server 200 determines whether the advertiser selected the “unconfirmed” menu option. If so, the server 200 branches to step 1494 of the method which is described below. If not, at step 1410, the server 200 causes the display, on the advertiser's telecom device 120, of a “make reservations” user interface having “search”, “site”, “demographics”, “reserve”, and “confirm” reservation process menu options. The server 200 also enables the advertiser to input search criteria for a search to locate, from the sites previously set-up by site owners in the system's database 306, possible sites at which the advertiser may desire to make a reservation for an advertisement: (1) by selection of a city from a geographical map displayed on the advertiser's telecom device 120; (2) by selection of a metro area from lists of metro areas displayed on the advertiser's telecom device 120; (3) by sequential selection of a site class and city from a list of available site classes and cities having one or more sites belonging to the selected site class displayed on the advertiser's telecom device 120; and, (4) by causing the display of a “go” button on the advertiser's telecom device 120, the selection of which by the advertiser starts a search for possible sites.

At step 1412 of the method, the server 200 awaits and receives from the advertiser, via the advertiser's telecom device 120, (1) the input of site criteria to be used in the performance of the search for possible sites and (2) selection of the “go” button. Upon receiving site criteria and selection of the “go” button, the server 200 uses the site criteria to perform, at step 1414, a search of the sites and associated site data previously set-up in the system database 306 by the system 100 in response to input from site owners for possible sites matching the advertiser's site criteria. After performing the search, at step 1416, the server 200 causes the display, on the advertiser's telecom device 120, of possible sites and associated information (i.e., associated with the sites by the system 100 and stored in the system database 200) matching the advertiser's site criteria for selection by the advertiser. For each displayed site, the associated information includes, for example and not limitation: the site's class, name, and location; the permitted ad length for advertisements; the corresponding name and duration of the season during which reservations may be made; and, the daily operating hours of the site. Then, at step 1418, the server 200 awaits and receives a selection of a site and direction to proceed (i.e., selection of the “demographics” reservation menu option) from the advertiser via the advertiser's telecom device 120.

Proceeding to step 1420, the server 200 causes the display, on the display of the advertiser's telecom device 120, of: (1) one or more photographic images of the selected site and site profile, season profile, and statistical information associated with the selected site; and, (2) a drop-down list box displaying and enabling the selection of available seasons for reservations for the selected site. Upon awaiting and receiving the advertiser's selection of a season (i.e., by selection of a season from the drop-down list box) and the “reserve” reservation menu option, the server 200, at step 1422, causes the display, on the advertiser's telecom device 120, of a user interface having: one or more calendars showing dates within the selected season and indicating dates for which no reservations have been made, dates for which reservations have been made, and dates selected by the advertiser; and, a “review” button to enable review of reservations for a date selected by the advertiser. Then, at step 1424, the server 200 awaits and receives an input selection from the advertiser, via the advertiser's telecom device 120, before advancing to step 1426 of the method.

At step 1426, the server 200 decides whether the advertiser selected the “reset” button (i.e., the display of which is described below) from the user interface. If so, at step 1428, the server 200 causes the re-display, on the advertiser's telecom device 120 in appropriate “reservation” drop-down list boxes (described below), of the numbers of advertising spots previously selected and saved in the system database 306 for each hour-long time segment of a reservation prior to the receipt of more recent unsaved selections of numbers of advertising spots. After causing the re-display of previously selected and saved data, the server 200 loops back to step 1424 of the method described above. If, at step 1426, the server 200 decides that the advertiser did not select the “reset” button, the server 200 continues at step 1430 where it ascertains whether the advertiser selected the “schedule” button (i.e., the display of which is described below). If so, the server 200 saves new data, or updates previously saved data in the system database 306 (i.e., which exists if the “schedule” button had previously been selected by the advertiser), for the reservation, at step 1432, to reflect the additional reservation of, deletion of, or changes to, the numbers of advertising spots in hour-long time segments received from the advertiser for one or more days in the selected season of the selected site. Then, at step 1434, the server 200 causes the display, on the advertiser's telecom device 120, of a “reservation schedule review report” showing the advertiser's reservation, including, but not limited to: (1) for each day on which advertising spots were selected and reserved by the advertiser, (a) the hour-long time segments in which advertising spots were reserved and for each such time segment, the rate associated with the reserved advertising spots, the numbers of advertising spots requested, the numbers of advertising spots actually reserved, and the price of the reserved advertising spots, and (b) the total cost (or, price) of reserved advertising spots for the day; (2) the reservation's cost per thousand impressions; (3) the reservation's total number of impressions; and, (4) the sub-total cost of the reserved advertising spots. The server 200 then returns to step 1424 of the method.

If, at step 1430, the server 200 ascertains that the advertiser did not select the “schedule” button, the server 200 determines, at step 1436, whether the advertiser selected the “review” button. If so, the server 200 branches to step 1434 where the server 200 causes the display, on the advertiser's telecom device 120, of a “reservation schedule review report” as described above. If not, the server 200 moves forward to step 1438 of the method, where the server 200 decides whether the advertiser selected a “date” from one of the calendars previously displayed on the advertiser's telecom device 120. If a date was selected, the server 200 causes, at step 1440, the display of a legend at the location of the selected date on the calendar to indicate the selection of the date. Then, at step 1442, the server 200 causes the display, on the advertiser's telecom device 120, at a location adjacent to the calendars: (1) a row and column matrix displaying, in rows for each hour-long time segment of the selected date during which advertising spots are possibly reservable, (a) the rate and availability of advertising spots, and (b) a “reservation” drop-down list box which (i) shows the number of advertising spots, if any, currently reserved by the advertiser for the respective hour-long time segment of the reservation, and (ii) enables the advertiser to select, if any advertising spots are available for reservation, advertising spots (i.e., in sets or groups of spots-typically, in sets of eight spots or multiples thereof) during that hour-long time segment for presentation of advertisements; (2) a “schedule” button; and, (3) a “reset” button. The server 200 then loops back to step 1424 to await and receive input selection from the advertiser.

If the server 200 decides, at step 1438, that the advertiser selected a “date” from one of the calendars previously displayed on the advertiser's telecom device 120, the server 200 ascertains, at step 1444, whether the advertiser selected a “reservation” drop-down list box. If not, the server 200 advances to step 1452 described below. If so, at step 1446, the server 200 causes the display on the advertiser's telecom device 120, if advertising spots are available, of a drop-down list of desired numbers of advertising spots for the corresponding hour-long time segment which are available for selection by the advertiser, and allows the advertiser to select a desired number of advertising spots from the drop-down list. Then, at step 1148, the server 200 receives the selection of a desired number of advertising spots from the advertiser via the drop-down list and updates the display of the respective “reservation” drop-down list box to reflect the advertiser's selection. Upon updating the display of the respective “reservation” drop-down list box, the server 200 returns to step 1424 to await and receive input from the advertiser.

At step 1450, the server 200 causes the display, on the advertiser's telecom device 120, of a user interface having: a “reservation schedule confirmation report”; a “campaign” drop-down list box; an “advertisement” drop-down list box; a “promo code” text input box; and, “redeem”, “order”, “save 24 hours”, and “start over” buttons. The “reservation schedule confirmation report”, preferably, includes: (1) the name and location of the site for which the reservation is being made; (2) the season and duration of the season at the site during which the reservation is being made; (3) for each day on which advertising spots were selected for reservation by the advertiser, (a) the hour-long time segments in which advertising spots were selected and for each such time segment, (i) the rate associated with the selected advertising spots, (ii) the numbers of advertising spots actually being reserved (i.e., since the system 100 may not be able to accommodate or provide the desired number of advertising spots selected by the advertiser from the respective “reservation” drop-down list box, (iii) the discount, if any, applied to the cost of the advertising spots, and, (iv) the price, or cost, of the advertising spots including any credited discount; (4) the sub-total cost for the reservation; (5) the promotion amount, if any, to be deducted from the sub-total cost; (6) the grand total cost for the reservation; (7) the average cost of the reservation per thousand impressions; and, (8) the total number of impressions which are estimated for the reservation.

After causing the display of the user interface and the “reservation schedule confirmation report”, the server 200 awaits and receives, at step 1452, an input selection from the advertiser via the advertiser's telecom device 120. Then, at step 1454, the server 200 determines whether the advertiser selected the “start over” button. If so, the server 200 branches back to step 1404 of the method to restart the make reservation process 1400. If not, the server 200, at step 1456, ascertains whether the advertiser selected the “save 24 hours” button. If so, the server 200 saves the reservation in the system database 306 for the selected campaign (described below), with the selected advertisement, if any is selected, for presentation during the advertising spots of the reservation, and with its “confirmed/unconfirmed” status set to “unconfirmed” to indicate that the reservation is being held for twenty-four hours without the submission of a payment therefor. Then, the server 200 advances to step 1494 of the method (described below). If, at step 1456, the server 200 ascertains that the advertiser did not select the “save 24 hours” button, the server 200 decides, at step 1460, whether the advertiser input a promotion code in the “promo code” text box and selected the “redeem” button. If so, the server 200 deducts, or applies, the discount corresponding to the input promo code (i.e., previously input by the site owner and saved in the system database 306 via the site manager application 600) from the sub-total cost for the reservation, updates the grand total cost of the reservation accordingly, and loops back to step 1452 to await and receive an input selection from the advertiser.

If, at step 1460, the server 200 decides that the advertiser did not select the “redeem” button, the server 200 determines, at step 1464, whether the advertiser selected the “campaign” drop-down list box. If not, the server 200 continues operation according to step 1472 of the method described below. If so, the server 200 advances to step 1466 where it causes the display, on the advertiser's telecom device 120, of a drop-down list containing the names of advertising campaigns previously set-up by the system 100 and advertiser in accordance with the campaigns application 1000, and allows the advertiser to select an advertising campaign therefrom. Next, at step 1468, the server 200 receives the selection of an advertising campaign from the advertiser, via the “campaign” drop-down list box, and updates the “campaign” drop-down list box to reflect the advertiser's selection. Subsequently, at step 1470, the server 200 associates the selected advertising campaign with the reservation, and updates previously saved reservation and campaign data in the system database 306 accordingly before looping back to step 1452 to await and receive an input selection from the advertiser.

The server 200 continues operation, at step 1472, if it decided that the advertiser did not select the “campaign” drop-down list box. At step 1472, the server 200 ascertains whether the advertiser selected the “advertisement” drop-down list box. If not, the advertiser selected the “order” button at step 1452 and the server 200 proceeds to step 1480 described below. If so, at step 1474, the server 200 causes the display, on the advertiser's telecom device 120, of an “advertisement” drop-down list which includes the names of advertisements previously created and stored in the advertisers ad portfolio for selection by the advertiser, and allows the advertiser to select an advertisement. Then, at step 1476, the server 200 receives from the advertiser, via the advertiser's telecom device 120, a selection, or identification, of an advertisement name and, hence, an advertisement, from the drop-down list of advertisement names to associate with, or assign to, the reservation. The server 200, subsequently, updates the “advertisement” drop-down list box with the name of the selected advertisement. Next, at step 1478, the server 200 associates the selected advertisement with the reservation being made and updates previously saved reservation data accordingly before returning to step 1452 described above.

If, at step 1472, the server 200 ascertains that the advertiser did not select the “advertisement” drop-down list box, the advertiser selected the “order” button (i.e., thereby instructing the system 100 that the advertiser desires to “order”, or “confirm”, the reservation being made) and the server 200 proceeds to step 1480 of the method. At step 1480, the server 200 causes the display, on the advertiser's telecom device 120, of a user interface having selectable payment method options, a “check out” button, and a “cancel” button. The selectable payment method options provide the advertiser with options selectable to instruct the system 100 as to how the advertiser desires to pay for the reservation, and include a credit card option (including, the selection of a previously input, through the accounts application 318, and stored credit card account number or the input of a new credit card account number) and an electronic checking account option (i.e., the account number therefor having been previously input by the advertiser and stored by the system 100 in the system database 306 via the accounts application 318). Then, at step 1482, the server 200 awaits and receives an input and/or selection from the advertiser via the advertiser's telecom device 120.

At step 1484, the server 200 determines whether the advertiser selected and/or input a payment method option. If so, the server 200 branches to step 1486 where it updates the displayed user interface to reflect the selected and/or input payment method options before returning to step 1482 to await further input from the advertiser. If, at step 1484, the server 200 determines that the advertiser did not select and/or input a payment method option, the server 200 advances to step 1488 where it decides whether the advertiser selected the “check out” button. If not, the advertiser selected the “cancel” button and the server 200 loops back to step 1402 in order to restart the reservations application 1400. If so, at step 1490, the server 200 associates the reservation and payment method information. Then, at step 1492, the server 200 sets the reservation's “confirmed/unconfirmed” status to indicate that the reservation has been ordered, or paid for, and updates, in the system database 306, the previously stored data for the reservation accordingly. After updating the reservation data, the server 200 branches back to step 1410 to begin the reservation process for another reservation.

If, at step 1408, the server 200 determines that the advertiser selected the “unconfirmed” menu option, the server 200 advances to step 1494 where the server 200 causes the display, on the advertiser's telecom device 120, of a user interface comprising: a table listing unconfirmed reservations (i.e., reservations having their “confirmed/unconfirmed” status set to “unconfirmed” because they have not yet been “ordered” or paid for by the advertiser) for each of the advertiser's campaigns with each unconfirmed reservation having an “ad name” drop-down list box showing the name of the currently selected advertisement therefor; a “change ads” button, a “reset” button; and, an “order selections” button. After causing the display of the user interface, the server 200 awaits and receives input and/or a selection from the advertiser via the advertiser's telecom device 120 at step 1496. Then, the server 200 determines, at step 1498, whether the advertiser selected the “ad name” drop-down list box. If not, the server 200 proceeds to step 1506 described below. If so, at step 1500, the server 200 causes the display, on the advertiser's telecom device 120, of a drop-down list of names of advertisements from the advertiser's ad portfolio saved in the system's database 306 and enables the advertiser to select a name of an advertisement for association with the respective reservation to which the “ad name” drop-down list box corresponds. The advertisement having the ad name selected by the advertiser will be presented by the system 100 during the advertising spots and at the site selected for the reservation. Continuing at step 1502, the server 200 receives the selection of a name of an advertisement from the drop-down list of advertisement names. In response, at step 1504, the server 200 causes the display, on the advertiser's telecom device 120, of the name of the selected advertisement in the “ad name” drop-down list box and loops back to step 1496 to await and receive advertiser input.

At step 1506, the server 200 determines that the advertiser did not select the “ad name” drop-down list box, the server 200 ascertains whether the advertiser selected the “change ads” button. If so, at step 1508, the server 200 saves the selected advertisement received from the advertiser, via the “ad name” drop-down list box, with the reservation data previously stored by the system 100 for the reservation in the system database 306. The server 200 then returns to step 1496 to await and receive further input from the advertiser. If the server 200 ascertains, at step 1506, that the advertiser did not select the “change ads” button, the server 200, at step 1510, decides whether the advertiser selected the “reset” button. If not, the advertiser selected the “cancel” button and the server 200 branches back to step 1480 to re-display the user interface having payment method options. If so, the server 200 causes the display of the names of the advertisements in the “ad name” drop-down list boxes of each “unconfirmed” reservation that were previously displayed therein prior to the advertiser's most recent selection of the “change ads” button.

Whereas this invention has been described in detail with particular reference to its most preferred embodiment, it is understood that variations and modifications can be effected within the spirit and scope of the invention, as described herein before and as defined in the appended claims. The corresponding structures, materials, acts, and equivalents of all means plus function elements, if any, in the claims below are intended to include any structure, material, or acts for performing the functions in combination with other claimed elements as specifically claimed.

We claim:

1. A method of managing and creating an advertisement for presentation on an electronic billboard, the method comprising the steps of:
receiving an advertisement from an advertiser for presentation on an electronic billboard;
enabling advertiser to make a reservation at a site for an electronic advertisement;
processing a reservation for an advertisement on a site which has been accepted an advertiser; and
maintaining an advertisement presented on an electronic billboard based on advertiser preferences and site owner preferences.

2. The method of claim 1, wherein the receiving an advertisement step includes receiving a web address of the advertisement.

3. The method of claim 1, wherein the receiving an advertisement step includes an advertisement creation user interface for an advertiser to create an advertisement.

4. The method of claim 3, wherein the advertisement creation user interface includes an advertisement toolbar, wherein an advertiser may drag and drop data into the advertisement toolbar for constructing the advertisement.

5. The method of claim 4, wherein the data includes images, text, and background music for the advertisement.

6. The method of claim 1, wherein enabling an advertiser to make a reservation step includes the step of providing a season planner user interface for establishing the season during which the advertisement is displayed on the electronic billboard.

7. The method of claim 6, wherein the providing a season planner user interface step includes receiving from a site owner the name of the advertisement, length of advertisement, price of advertisement, impressions information, hours of operation information, start date, end date, and season description.

8. The method of claim 6, wherein the providing a season planner user interface step includes the step of receiving a selection by an advertiser of an electronic billboard for presenting the advertisement.

9. The method of claim 6, further including the step of providing a rate planning user interface which lists one or more site owners for an advertiser to select and presents pertinent information for the selected site owner.

10. The method of claim 9, wherein pertinent information includes advertisement length, rate, and promotional information.

11. The method of claim 1, wherein the processing a reservation for an advertisement step includes the step of allowing an advertiser to cancel, order, or hold a reservation.

12. The method of claim 11, wherein allowing an advertiser to hold a reservation comprises allowing advertisers to hold a reservation for 24 hours.

13. The method of claim 11, wherein the processing a reservation for an advertisement step includes the step of allowing an advertiser to set up and maintain one or more advertising campaigns having one or more reservations.

14. The method of claim 1, wherein the maintaining an advertisement presented on an electronic billboard step includes accepting changes by an advertiser to an advertisement, and making the changes to the advertisement.

15. The method of claim 1, wherein the maintaining an advertisement presented on an electronic billboard step includes allowing acceptance or rejection an advertisement for presentation on an electronic billboard.

16. A system for managing and creating an electronic advertisement for an electronic billboard, the system comprising:
a site owner computing device comprising a device for presenting an advertisement, coupled to a reservation server and to an advertiser computing device;
an advertiser computing device, coupled to a reservation server and to an advertiser computing device; and
a reservation server coupled to the site owner computing device and advertiser computing device, comprising a memory containing a program module operative to provide an advertisement creation user interface and to:
receive an advertisement from an advertiser for presentation on an electronic billboard;
enable an advertiser to make a reservation at a site for an electronic advertisement;
process a reservation for an advertisement on a site which has been accepted an advertiser; and,
maintain an advertisement displayed on an electronic billboard based on advertiser preferences and site owner preferences;
wherein a communication link couples the site owner computing device, the advertiser computing device, and the reservation server.

17. The system of claim 16, wherein the advertisement creation user interface includes a toolbar which allows features of the advertisement to be dragged and dropped into the toolbar to construct the electronic advertisement.

18. The system of claim 17, wherein the features include one or more of the following: music, images, and text.

19. The system of claim 17, wherein the toolbar is divided into one or more frames with each frame representing a portion of the length of the advertisement.

20. The system of claim 16, wherein the reservation server program module includes instructions to provide a season planner user interface for receiving, changing, and presenting season data concerning a reservation for an advertisement.

21. The system of claim 20, wherein the instructions to provide a season planner user interface further includes instructions to allow selection by an advertiser of a site owner computing device.

22. The system of claim 16, wherein the reservation server program module includes instructions to provide a rate planner user interface for receiving, presenting, and changing rate data concerning a reservation for an advertisement

23. The system of claim 16, wherein the communication link is a telecommunications link.

24. An apparatus for managing reservations for an electronic advertisement, the apparatus comprising:
a processing unit;
a memory coupled to the processing unit and comprising a program module with instructions operative to:
receive an advertisement from an advertiser for presentation on an electronic billboard;
enable an advertiser to make a reservation at a site for an electronic advertisement;
process a reservation for an advertisement on a site which has been accepted an advertiser; and
maintain an advertisement displayed on an electronic billboard based on advertiser preferences and site owner preferences,
wherein the apparatus is coupled to a site owner device and an advertiser device by a communications link.

25. The apparatus of claim 24, wherein the communications link comprises a telecommunications link.
